(19) United States
(12) Patent Application Publication
(10) Pub. No.: US 2018/0013971 A1
(43) Pub. Date: Jan. 11, 2018

(54) OBSERVATION SYSTEM AND OBSERVATION METHOD

(71) Applicant: OLYMPUS CORPORATION, Tokyo (JP)

(72) Inventors: Hideaki MATSUOTO, Fuchu-shi (JP); Osamu NONAKA, Sagamihara-shi (JP)

(73) Assignee: OLYMPUS CORPORATION, Tokyo (JP)

(21) Appl. No.: 15/637,086

(22) Filed: Jun. 29, 2017

(30) Foreign Application Priority Data
Jul. 6, 2016 (JP) 2016-134170

(51) Int. Cl. H04N 5/374; H04N 3/14

(52) U.S. Cl. CPC H04N 5/3741; H04N 3/1587

(57) ABSTRACT

An observation system includes: a plurality of imaging sections to image one or more samples; a plurality of driving mechanisms that respectively move the imaging sections to change an imaging position for the samples; and a control circuit that controls operations of the driving mechanisms and the imaging sections to cause the imaging sections to image the samples, while causing the driving mechanisms to respectively move the imaging sections. The control circuit imposes different limitations on movement patterns of the imaging sections depending on a characteristic of the samples.

### CROSS-REFERENCE TO RELATED APPLICATIONS

This application is based upon and claims the benefit of priority from prior Japanese Patent Application No. 2016-134170, filed Jul. 6, 2016, the entire contents of which are incorporated herein by reference.

### BACKGROUND OF THE INVENTION

### 1. Field of the Invention

The present invention relates to an observation system and an observation method.

### 2. Description of the Related Art

In general, an apparatus wherein a culture vessel is statically placed in an incubator and images of cultured cells or the like in the culture vessel are taken, is known in the art. For example, Jpn. Pat. Appin. KOKAI Publication No. 2005-295818 discloses a technique related to an apparatus which takes a number of images while moving a camera (imaging section) inside an incubator so as to take images of cells existing in a wide range of a culture vessel. In the apparatus described above, a long period of time is required to take images in a wide range. The imaging time can be reduced if the number of imaging sections is increased.

### BRIEF SUMMARY OF THE INVENTION

An aspect of the present invention provides an observation system comprising: a plurality of imaging sections to image one or more samples; a plurality of driving mechanisms that respectively move the imaging sections to change an imaging position for the samples; and control circuit that controls operations of the driving mechanisms and the imaging sections to cause the imaging sections to image the samples, while causing the driving mechanisms to respectively move the imaging sections, wherein the control circuit imposes different limitations on movement patterns of the imaging sections depending on a characteristic of the samples.

Another aspect of the present invention provides an observation method using an observation system including a plurality of imaging sections to image one or more samples, and a plurality of driving mechanisms that respectively move the imaging sections to change an imaging position for the samples, the method comprising: determining a characteristic of the samples; determining movement patterns of the imaging sections based on the characteristic of the samples; and controlling operations of the driving mechanisms and the imaging sections to cause the imaging sections to image the samples, while causing the driving mechanisms to respectively move the imaging sections.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an outline of a configuration example of an observation system according to a first embodiment.

FIG. 2 is a block diagram showing an outline of a configuration example of the observation system according to the first embodiment.

FIG. 3 is a side view showing an outline of a configuration example of an image acquisition unit and a sample according to the first embodiment.

FIG. 4A is a flowchart illustrating an example of processing performed by a controller according to the first embodiment.

FIG. 4B is a flowchart illustrating an example of processing performed by a controller according to the first embodiment.

FIG. 5 is a view showing an outline of an example of an image for selection.

FIG. 6 is a view showing an outline of an example of an image for selection.

FIG. 7 is a view for explaining a case of two samples in scanning by an observation apparatus according to the first embodiment.

FIG. 8 is a view for explaining a case of one sample in scanning by the observation apparatus according to the first embodiment.

FIG. 9 is a diagram for explaining information relating to a movement pattern of the observation apparatus according to the first embodiment.

FIG. 10 is a view for explaining a case of two samples in scanning by the observation apparatus according to the first embodiment.

FIG. 11 is a view for explaining a case of one sample in scanning by the observation apparatus according to the first embodiment.

FIG. 12 is a flowchart illustrating an example of observation apparatus control processing according to the first embodiment.

FIG. 13 is a flowchart illustrating an example of scan and image acquisition processing according to the first embodiment.

FIG. 14 is a view showing an outline of a configuration example of an observation system according to a second embodiment.

FIG. 15 is a schematic diagram for explaining a reflection pattern of a transparent plate according to the second embodiment.

FIG. 16 is a block diagram showing an outline of a configuration example of a self-propelled unit according to the second embodiment.

FIG. 17A is a flowchart illustrating an example of control processing performed by a controller according to the second embodiment.

FIG. 17B is a flowchart illustrating an example of control processing performed by the controller according to the second embodiment.

FIG. 18 is a flowchart illustrating an example of observation apparatus control processing according to the second embodiment.

FIG. 19 is a block diagram showing an outline of a configuration example of an observation system according to a third embodiment.

FIG. 20 is a flowchart illustrating an example of operations of the observation system according to the third embodiment.

### DETAILED DESCRIPTION OF THE INVENTION

### First Embodiment

The first embodiment of the present invention will be explained with reference to the drawings. An observation system of this embodiment is a system which takes images of a cell, a cell group, and a tissue which are being cultured, and which makes a record of the numbers of cells or cell groups and the morphology thereof.

### <Configuration of Observation System>

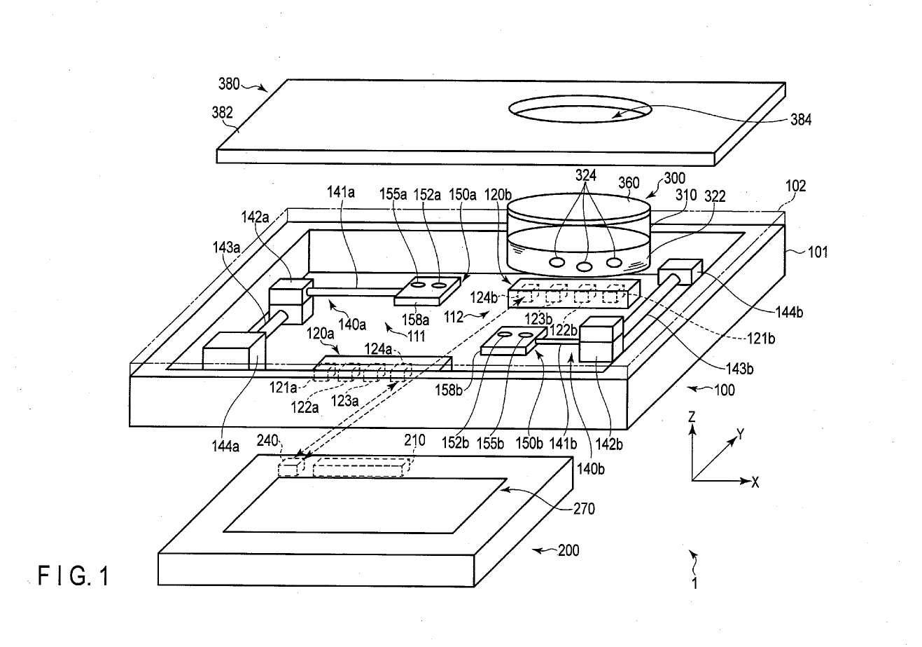

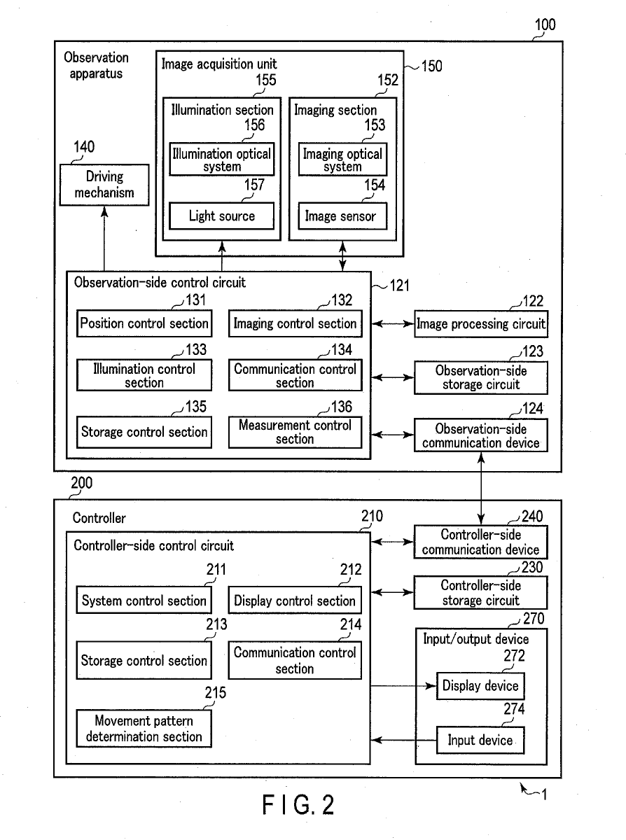

FIG. 1 is a schematic view illustrating an outline of the appearance of an observation system 1. FIG. 2 is a block diagram illustrating a configuration example of the observation system 1. The observation system 1 includes an observation apparatus 100 and a controller 200. As shown in FIG. 1, the observation apparatus 100 is approximately plate-shaped. The observation apparatus 100 is provided, for example, inside an incubator, and a sample 300 to be observed is arranged on top of the observation apparatus 100. For the sake of explanation, an x-axis and a y-axis perpendicular to each other are defined in a plane parallel to the surface of the observation apparatus 100 on which the sample 300 is arranged, and a z-axis is defined as an axis perpendicular to both the x-axis and the y-axis. A transparent plate 102 is provided on top of the observation apparatus 100. An image acquisition unit is provided inside a casing 101 of the observation apparatus 100. The observation apparatus 100 takes an image of the sample 300, via the transparent plate 102 interposed, and the image of the sample 300 is acquired thereby. On the other hand, the controller 200 is provided outside the incubator. The observation apparatus 100 and the controller 200 communicate with each other. The controller 200 controls operations of the observation apparatus 100.

### (Sample)

An example of the sample 300 to be observed by the observation system 1 will be described below. A culture medium 322 is in a vessel 310, and cells 324 are cultured in the culture medium 322. The vessel 310 may be, for example, a petri dish, a culture flask, a multiwell plate, or the like. The vessel 310 is a culture vessel for culturing biological samples, for example. The vessel 310 is not limited to any specific shape or size. The culture medium 322 may be either a liquid medium or a solid medium. The cells 324 to be measured may be either adhesive cells or floating cells. Alternatively, the cells 324 may be spheroids or tissues. In addition, the cells 324 may be derived from any organisms or may be bacteria or the like. As described above, the sample 300 includes a living sample which is either the organisms itself or is derived from the organisms. A reflecting plate 360 is on top of the vessel 310. The reflecting plate 360 reflects illumination light, described later.

### (Observation Apparatus)

As shown in FIG. 1, the transparent plate 102 made of, for example, glass, is provided on top of the casing 101 of the observation apparatus 100. The sample 300 is statically placed on this transparent plate 102. Although FIG. 1 shows that the top plate of the casing 101 is entirely transparent, the observation apparatus 100 may be designed so that part of the top plate of the casing 101 is a transparent plate, and the remaining part of the top plate is opaque.

The transparent plate 102 may be overlaid with a fixing frame 380 to determine the position where the sample 300 is placed on the transparent plate 102 and to fix the sample 300. The fixing frame 380 may be designed so that it is arranged at a specific position with respect to the transparent plate 102. For example, the fixing frame 380 may have the same size as the transparent plate 102 The fixing frame 380 includes a fixing plate 382 and a hole 384 formed in the fixing plate 382. The hole 384 has a diameter slightly larger than the outer diameter of the vessel 310 of the sample 300. Therefore, in the state where the fixing frame 380 is placed on the transparent plate 102, the vessel 310 can be fixed in the hole 384. A plurality of fixing frames 380 of different types may be prepared in accordance with the types of vessels 310 of the sample 300. The fixing frame 380 may be employed; alternatively, it can be omitted.

Various elements of the observation apparatus 100 are provided inside the casing 101. The interior of the incubator has a temperature of 37° C. and a humidity of 95%. Since the observation apparatus 100 is used in an environment of high ambient temperature and humidity, the casing 101 is designed to maintain airtightness.

A first unit 111 and a second unit 112 are provided inside the casing 101. The first unit 111 and the second unit 112 have configurations similar to each other.

As shown in FIG. 1, the first unit 111 includes a first circuit group 120a, a first driving mechanism 140a, and a first image acquisition unit 150a. Similarly, the second unit 112 includes a second circuit group 120b, a second driving mechanism 140b, and a second image acquisition unit 150b. Since the first circuit group 120a and the second circuit group 120b are equivalent, these are each referred to as the circuit group, unless a distinction therebetween is necessary. Likewise, unless a distinction is particularly necessary, the first driving mechanism 140a and the second driving mechanism 140b are each referred to as the driving mechanism 140, and the first image acquisition unit 150a and the second image acquisition unit 150b are each referred to as the image acquisition unit 150.

In the first image acquisition unit 150a, a first support section 158a is provided with a first illumination section 155a for illuminating the sample 300. The first illumination section 155a emits illumination light in the direction toward the transparent plate 102, namely, in the direction toward the sample 300.

As shown in FIG. 1, a first imaging section 152a is provided near the first illumination section 155a of the first support section 158a. The first imaging section 152a takes an image of the region where the sample 300 is present, and thus acquires an image of the sample 300.

The first support section 158a on which the first imaging section 152a and the first illumination section 155a are fixed is moved by the first driving mechanism 140a. The first driving mechanism 140a is provided with a first X feed screw 141a and a first X actuator 142a for moving the first support section 158a in an X-axis direction. The first driving mechanism 140a is also provided with a first Y feed screw 143a and a first Y actuator 144a for moving the first support section 158a in a Y-axis direction.

The imaging position in a Z-axis direction is changed by changing the focus position of an imaging optical system of the first imaging section 152a. In other words, the imaging optical system is provided with a focus adjustment mechanism for moving a focusing lens in the optical axis direction. In place of the focus adjustment mechanism or in combination therewith, the first driving mechanism 140a may be provided with a Z feed screw and a Z actuator for moving the first support section 158a in the Z-axis direction.

The first circuit group 120a is provided with a first control circuit 121a, a first image processing circuit 122a, a first storage circuit 123a, and a first communication device 124a. The first control circuit 121a controls operations of the first driving mechanism 140a and the first image acquisition unit 150a. The first image processing circuit 122a performs various kinds of image processing for the image data obtained by the first imaging section 152a. The first storage circuit 123a stores, for example, programs and various parameters for use in the first control circuit 121a. The first storage circuit 123a also stores data obtained by the observation apparatus 100.

The first communication device 124a is a device which communicates with the controller 200. For example, wireless communications, such as Wi-Fi or Bluetooth are utilized for the communications. The observation apparatus 100 and the controller 200 may be connected by a wire, and wired communications may be carried out.

The second image acquisition unit 150b has a similar configuration as that of the first image acquisition unit 150a. Specifically, in the second image acquisition unit 150b, a second support section 158b is provided with a second illumination section 155b and a second imaging section 152b. Since the first support section 158a and the second support section 158b are equivalent, these are each referred to as the support section, unless a distinction therebetween is necessary. Similarly, since the first illumination section 155a and the second illumination section 155b are equivalent, these are each referred to as the illumination section 155, unless a distinction therebetween is necessary. Similarly, since the first imaging section 152a and the second imaging section 152b are equivalent, these are each referred to as the imaging section 152, unless a distinction therebetween is necessary.

The second driving mechanism 140b has a similar configuration to that of the first driving mechanism 140a. The second image acquisition unit 150b is moved by the second driving mechanism 140b. The second driving mechanism 140b is provided with a second X feed screw 141b and a second X actuator 142b for moving the second support section 158b in the X-axis direction. The second driving mechanism 140b is also provided with a second Y feed screw 143b and a second Y actuator 144b for moving the second support section 158b in the Y-axis direction. The imaging position in the Z-axis direction is changed by changing the focus position of an imaging optical system of the second imaging section 152b. In other words, the imaging optical system is provided with a focus adjustment mechanism for moving a focusing lens in the optical axis direction. In place of the focus adjustment mechanism or in combination therewith, the second driving mechanism 140b may be provided with a Z feed screw and a Z actuator for moving the second support section 158b in the Z-axis direction.

The second circuit group 120b has a similar configuration to that of the first circuit group 120a. The second circuit group 120b is provided with a second control circuit 121b, a second image processing circuit 122b, a second storage circuit 123b, and a second communication device 124b. The second control circuit 121b, the second image processing circuit 122b, the second storage circuit 123b, and the second communication device 124b respectively correspond to the first control circuit 121a, the first image processing circuit 122a, the first storage circuit 123a, and the first communication device 124a. The second control circuit 121b controls operations of the second driving mechanism 140b and the second image acquisition unit 150b. The second image processing circuit 122b performs various kinds of image processing for the image data obtained by the second imaging section 152b. The second storage circuit 123b stores, for example, programs and various parameters for use in the second control circuit 121b. The second storage circuit 123b also stores data obtained by the observation apparatus 100. The second communication device 124b is, for example, a device which communicates wirelessly with the controller 200.

Since the first control circuit 121a and the second control circuit 121b are equivalent, these are each referred to as the observation-side control circuit 121, unless a distinction therebetween is necessary. Since the first image processing circuit 122a and the second image processing circuit 122b are equivalent, these are each referred to as the image processing circuit 122, unless a distinction therebetween is necessary. Since the first storage circuit 123a and the second storage circuit 123b are equivalent, these are each referred to the observation-side storage circuit 123, unless a distinction therebetween is necessary. Since the first communication device 124a and the second communication device 124b are equivalent, these are each referred to as the observation-side communication device 124, unless a distinction therebetween is necessary.

Function blocks of the observation system 1 will be explained with reference to FIG. 2. Since the first unit 111 and the second unit 112 of the observation apparatus 100 are equivalent, FIG. 2 shows only one of them.

As shown in FIG. 2, the imaging section 152 includes an imaging optical system 153 and an image sensor 154. The imaging section 152 generates image data based on an image which is formed on the imaging plane of the image sensor 154 through the imaging optical system 153. The imaging optical system 153 is preferably a zoom optical system capable of changing its focal distance.

As shown in FIG. 2, the illumination section 155 includes an illumination optical system 156 and a light source 157. The illumination light emitted from the light source 157 illuminates the sample 300 through the illumination optical system 156. The light source 157 includes, for example, a light-emitting diode (LED). Although the illumination section 155 was described as being arranged in the support section 158, what is required in practice is merely that an emitting section of the illumination optical system 156 is arranged in the support section. For example, the light source 157 may be arranged at any position in the observation apparatus 100.

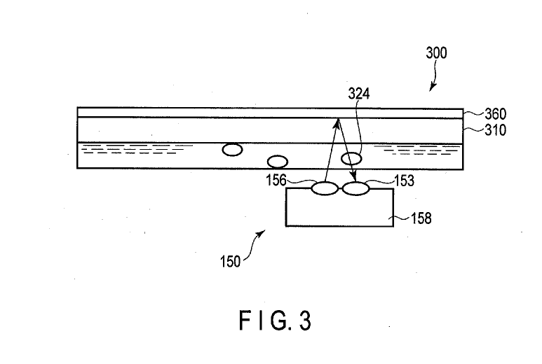

FIG. 3 is a schematic side view of the sample 300. As shown in FIG. 3, the illumination light emitted from the illumination optical system 156 of the illumination section 155 provided in the support section 158 in the image acquisition unit 150 falls on the reflecting plate 360 provided on top of the vessel 310, and is reflected by the reflecting plate 360. The reflected light illuminates the cell 324 and enters the imaging optical system 153 of the imaging section 152.

The observation-side control circuit 121 controls operations of each of the elements of the observation apparatus 100. As shown in FIG. 2, the observation-side control circuit 121 functions as a position control section 131, an imaging control section 132, an illumination control section 133, a communication control section 134, a storage control section 135, and a measurement control section 136. The position control section 131 controls operations of the driving mechanism 140 to control the position of the image acquisition unit 150. The imaging control section 132 controls operations of the imaging section 152 to cause the imaging section 152 to acquire an image of the sample 300. The illumination control section 133 controls operations of the illumination section 155. The communication control section 134 controls the communications with the controller 200 which are performed by using the observation-side communication device 124. The storage control section 135 controls the recording of data obtained by the observation apparatus 100. The measurement control section 136 controls the overall measurement, including measurement timing and the number of times the measurement is performed.

The image processing circuit 122 performs various kinds of image processing for the image data obtained by the imaging section 152. After the image processing by the image processing circuit 122, data is, for example, stored in the observation-side storage circuit 123 or transmitted to the controller 200 by way of the observation-side communication device 124. The observation-side control circuit 121 or the image processing circuit 122 may perform various kinds of analysis, based on the obtained image. For example, the observation-side control circuit 121 or the image processing circuit 122 extracts an image of a cell or cell group included in the sample 300, or counts the number of cells or cell groups, based on the obtained image. The results of the analysis thus obtained are, for example, stored in the observation-side storage circuit 123 or transmitted to the controller 200 by way of the observation-side communication device 124.

### (Controller)

The controller 200 is, for example, a personal computer (PC) or a tablet type information terminal. In FIG. 1, a tablet type information terminal is depicted.

The controller 200 is provided with an input/output device 270 including a display device 272 such as a liquid crystal display, and an input device 274 such as a touch panel. The input device 274 is not limited to the touch panel but may include a switch, a dial, a keyboard, a mouse, etc.

The controller 200 is also provided with a controller-side communication device 240. The controller-side communication device 240 is a device which communicates with the observation-side communication device 124, that is, the first communication device 124a and the second communication device 124b. The observation apparatus 100 and the controller 200 communicate with each other through the observation-side communication device 124 and the controller-side communication device 240.

The controller 200 is further provided with a controller-side control circuit 210 and a controller-side storage circuit 230. The controller-side control circuit 210 controls operations of each of the elements of the controller 200. The controller-side storage circuit 230 stores, for example, programs and various parameters for use in the controller-side control circuit 210. The controller-side storage circuit 230 also stores data obtained by and received from the observation apparatus 100.

The controller-side control circuit 210 functions as a system control section 211, a display control section 212, a storage control section 213, a communication control section 214, and a movement pattern determination section 215. The system control section 211 performs various operations for controlling the measurement of the sample 300. The display control section 212 controls operations of the display device 272. The display control section 212 causes the display device 272 to display the necessary information. The storage control section 213 controls the recording of information in the controller-side storage circuit 230. The communication control section 214 controls the communications with the observation apparatus 100 that are performed by way of the controller-side communication device 240. The movement pattern determination section 215 determines a movement pattern of the image acquisition unit 150 of the observation apparatus 100.

Each of the observation-side control circuit 121, the image processing circuit 122, and the controller-side control circuit 210 incorporates an integrated circuit, such as a central processing unit (CPU), an application specific integrated circuit (ASIC),or a field programmable gate array (FPGA). Each of the observation-side control circuit 121, the image processing circuit 122, and the controller-side control circuit 210 may be constituted by a single integrated circuit or by a combination of a number of integrated circuits. The observation-side control circuit 121 and the image processing circuit 122 may be made by a single integrated circuit. Each of the position control section 131, the imaging control section 132, the illumination control section 133, the communication control section 134, the storage control section 135, and the measurement control section 136 of the observation-side control circuit 121 may be constituted by a single integrated circuit or by a combination of a number of integrated circuits. Two or more of the position control section 131, the imaging control section 132, the illumination control section 133, the communication control section 134, the storage control section 135, and the measurement control section 136 may be constituted by a single integrated circuit or the like. Likewise, each of the system control section 211, the display control section 212, the storage control section 213, the communication control section 214, and the movement pattern determination section 215 of the controller-side control circuit 210 may be constituted by a single integrated circuit or by a combination of a number of integrated circuits. Two or more of the system control section 211, the display control section 212, the storage control section 213, the communication control section 214, and the movement pattern determination section 215 may be constituted by a single integrated circuit or the like. The operations of these integrated circuits are executed, for example, in accordance with programs stored in the observation-side storage circuit 123 or the controller-side storage section 230, or in accordance with the programs stored in the storage regions of the integrated circuits.

### <Operation of Observation System>

Operations of the observation system 1 will be described. In the observation system 1 of this embodiment, the observation apparatus 100 includes two units, namely, the first unit 111 and the second unit 112, as units for observing the sample 300. The first unit 111 and the second unit 112 perform an optimal operation in cooperation with each other. For example, when the user inputs the number of samples 300 using the controller 200, the observation apparatus 100 acquires images of the samples 300 of the input number by an optimal operation in accordance with the input number of samples.

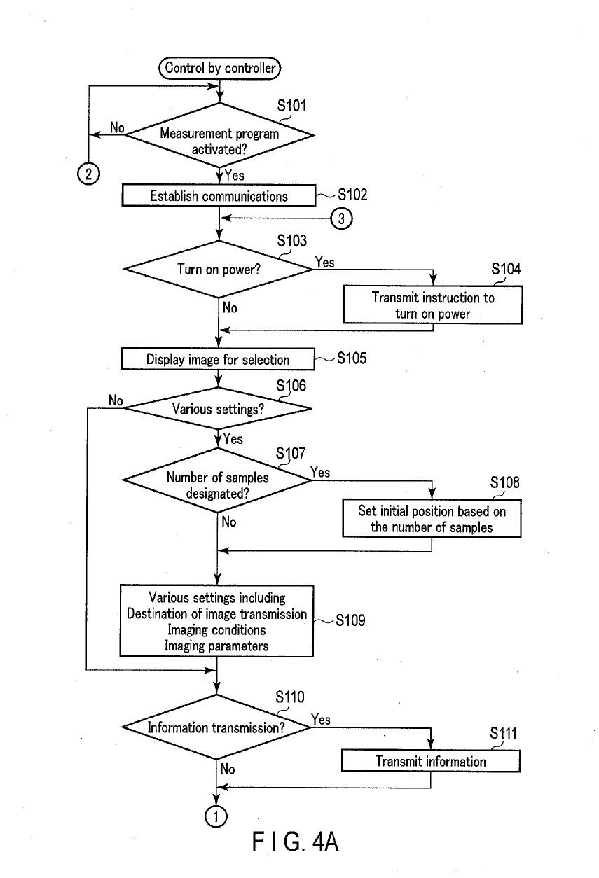

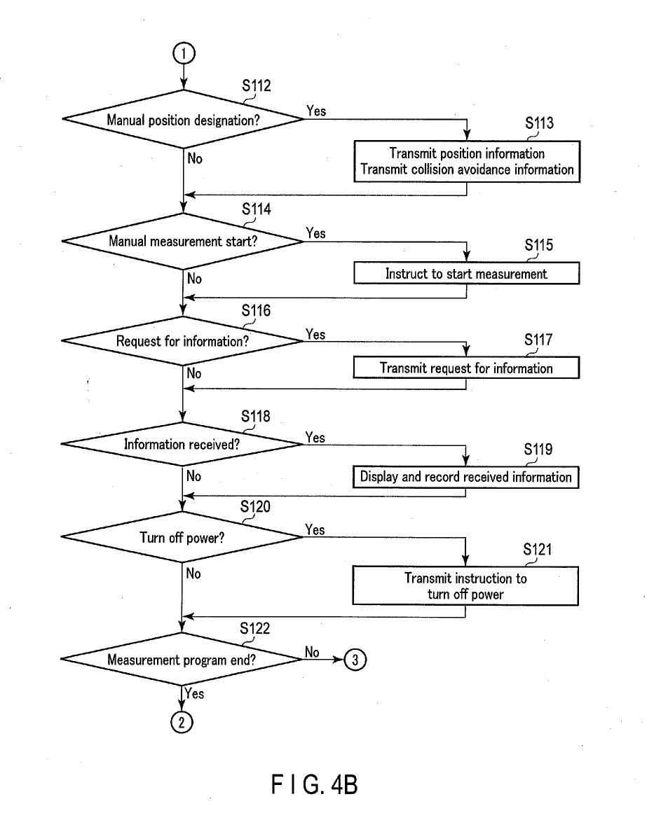

Control processing performed by the controller 200 will be described with reference to the flowcharts shown in FIGS. 4A and 4B. The processing indicated in the flowcharts of FIGS. 4A and 4B starts after the observation apparatus 100, the controller 200, and the sample 300 are set in place.

In step S101, the controller-side control circuit 210 determines whether or not a measurement program according to the present embodiment is activated. If the measurement program is not activated, the processing of step S101 is repeated. The controller 200 is not limited to the functions of the controller of the observation system of the present embodiment but may have various functions. Therefore, when the measurement program is not activated, the controller 200 may operate as a system other than the observation system 1. If it is determined that the measurement program is activated, the processing advances to step S102.

In step S102, the controller-side control circuit 210 establishes communications with the observation apparatus 100. The observation apparatus 100 and the controller 200 operate so that communications between them are established. The communications established then may be low-power-consumption communications that is irrelevant to step S203 of the observation apparatus control and that only enables the transmission of an instruction to turn on the power of the observation apparatus 100.

In step S103, the controller-side control circuit 210 determines whether or not the user is requesting that the power of the observation apparatus 100 be turned on. For example, if an instruction to turn on the power of the observation apparatus 100 is supplied from the input device 274, the controller-side control circuit 210 determines that the user is requesting that the power be turned on. If the instruction to turn on the power is not supplied, the processing advances to step S105. If the instruction to turn on the power of the observation apparatus 100 is supplied, the processing advances to step S104. In step S104, the controller-side control circuit 210 transmits an instruction to turn on the power of the observation apparatus 100 to the observation apparatus 100. Subsequently, the processing advances to step S105.

Upon receipt of the instruction to turn on the power of the observation apparatus 100 from the controller 200, the power of the observation apparatus 100 is turned on. When the power of the observation apparatus 100 has already been on, the observation apparatus 100 does not perform any processing even if it receives the instruction to turn on. The communication means used in the embodiment may be low-power-consumption communications such as Bluetooth Low Energy.

In step S105, the controller-side control circuit 210 causes the display device 272 to display an image for selection. The image for selection is an image for use in input by the user concerning operations of the observation system 1. The user can input operation conditions etc. of the observation system 1 by means of the touch panel provided on the image for selection displayed on the display device 272, while checking the image for selection.

In step S106, the controller-side control circuit 210 determines whether or not various settings are input. The user can input setting items by means of the input device 274, while looking at an image displayed on the display device 272 in the processing of, for example, step S105. The setting items include a characteristic of samples to be observed, for example, the number of samples. If various settings are not input, the processing advances to step S110. If various settings are input, the processing advances to step S107.

In step S107, the controller-side control circuit 210 determines whether or not the number of samples is designated by the user. If the number of samples is not designated, the processing advances to step S109. If the number of samples is designated, the processing advances to step S108. In step S108, the controller-side control circuit 210 determines an initial position of the image acquisition unit 150 based on the number of samples. Subsequently, the processing advances to step S109.

In this embodiment, the number of samples is described as a characteristic of samples; however, the number of samples is a mere example of characteristics of samples. The characteristic of samples is not necessarily the number of samples. In other words, the determination performed in step S107 may be any determination that can be a reason to determine whether a plurality of image acquisition units 150 should move in cooperation or independently. When the image acquisition units 150 move in cooperation, the controller-side control circuit 210 needs to estimate or ascertain a relative position or subsequent movement to avoid a collision or interference between the image acquisition units 150. When the image acquisition units 150 move independently, if territories (region assignments or assigned regions) of the respective units are determined, ascertainment or detailed estimates relating to the relative position or subsequent movement can be eliminated as long as the territories are maintained. Thus, the determination in step S107, depending on situations, may be anything that embodies an idea for preventing the image acquisition units 150 from positionally interfering with one another.

In step S109, the controller-side control circuit 210 performs various settings. The settings include, for example, the following. The controller 200 or another device may be designated as a destination of transmission of an image. Conditions for imaging the sample 300 may also be designated. As the conditions for imaging, for example, a predetermined time interval, such as one hour, may be designated, a time to perform imaging may be specified, or a condition based on results of analyzing an obtained image may be set. Furthermore, imaging parameters using the imaging section 152, such as an exposure time, an aperture value, and a focus position, may be designated. A scanning pattern for imaging while scanning the sample 300 may also be designated. All necessary settings other than the above may be set. The settings may include a setting in consideration of a characteristic of the sample. After step S109, the processing advances to step S110.

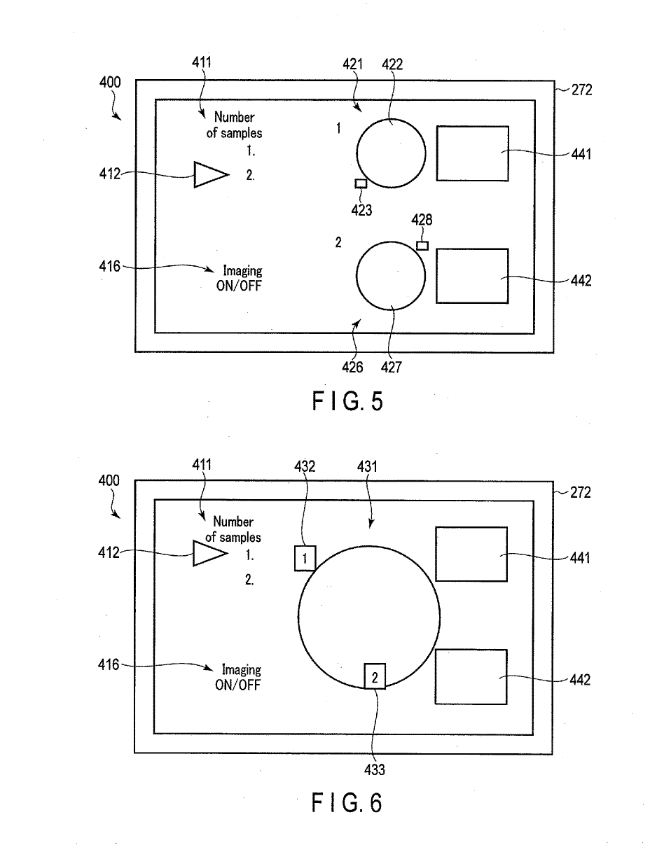

An example of operations of step S105 to step S109 will be explained with reference to the drawings. FIG. 5 shows an outline of an example of an image 400 for selection displayed on the display device 272. As shown in FIG. 5, the image 400 for selection includes a sample number display 411 indicating the number of samples selected by the user. The sample number display 411 includes a cursor 412. The cursor 412 indicates “1” or “2” as the number of samples selected by the user. The user can select the number of samples by touching a display of “1” or “2” on the input device 274, which is the touch panel. In the example shown in FIG. 5, “2” is selected as the number of samples.

The image 400 for selection also includes an imaging selection display 416 for selection of turning on or off the power of the observation apparatus 100. The user can select turning on or off the power of the observation apparatus 100 by touching “ON” or “OFF” by means of, for example, the input device 274, which is the touch panel.

Furthermore, in the example shown in FIG. 5, since “2” is selected as the number of samples, the image 400 for selection includes a first sample display 421 and a second sample display 426. The first sample display 421 includes a display 422 representing one of the two samples, and a display 423 indicating a part of the sample currently imaged, that is, a position of the first imaging section 152a of the first unit 111 relative to the sample. Similarly, the second sample display 426 includes a display 427 representing one of the two samples, and a display 428 indicating a part of the sample currently imaged, that is, a position of the second imaging section 152b of the second unit 112 relative to the sample.

Furthermore, the image 400 for selection includes a first acquired image display region 441 indicating an image taken by the first imaging section 152a of the first unit 111, and a second acquired image display region 442 indicating an image taken by the second imaging section 152b of the second unit 112.

In addition, the image 400 for selection may include a display for setting a destination of transmission of an image, conditions for imaging, an imaging parameter, a scanning pattern, etc., and a menu readout display for displaying the aforementioned settings.

FIG. 6 shows an example of the image 400 for selection indicating that “1” is selected as the number of samples. In this case, as shown in FIG. 6, the cursor 412 in the sample number display 411 indicates “1”. At this time, a sample display 431 represents one sample. The sample display 431 indicates a part of the sample currently imaged, that is, the sample display 431 includes a display 432 indicating a position of the first imaging section 152a of the first unit 111 relative to the sample, and a display 433 indicating a position of the second imaging section 152b of the second unit 112 relative to the sample. Furthermore, the image 400 for selection includes a first acquired image display region 441 indicating an image taken by the first imaging section 152a of the first unit 111, and a second acquired image display region 442 indicating an image taken by the second imaging section 152b of the second unit 112.

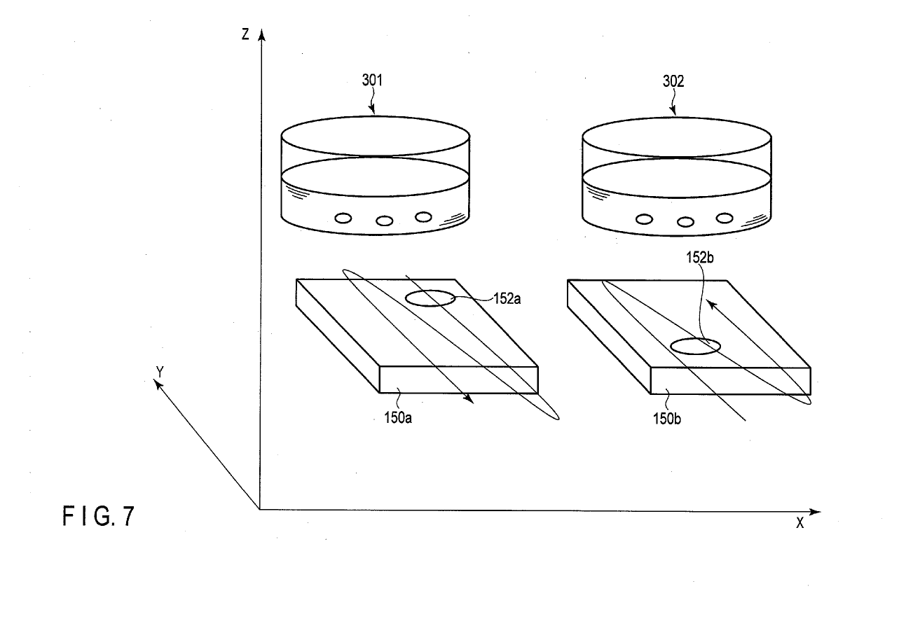

Imaging operations in the case of two samples will be explained with reference to FIG. 7. It is assumed that there are two samples: a first sample 301 and a second sample 302 as shown in FIG. 7. In this case, the observation apparatus 100 images the first sample 301 using, for example, the first image acquisition unit 150a of the first unit 111, and images the second sample 302 using the second image acquisition unit 150b of the second unit 112. Specifically, the first image acquisition unit 150a scans a region where the first sample 301 is placed, and the second image acquisition unit 150b scans a region where the second sample 302 is placed. At this time, the first image acquisition unit 150a and the second image acquisition unit 150b may move in any way as long as they do not collide with each other; for example, they may recede from each other as shown in FIG. 7. Alternatively, they may come near each other, or move in the same direction. Thus, if the number of samples is two, the first image acquisition unit 150a and the second image acquisition unit 150b move individually.

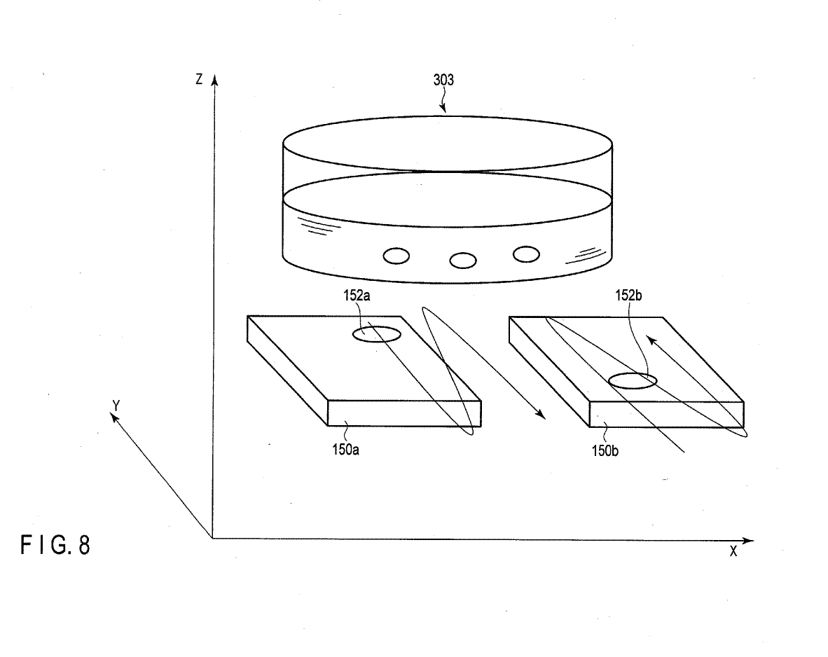

Imaging operations in the case of one sample will be explained with reference to FIG. 8. It is assumed that there is a third sample 303, which is larger than the first sample 301 and the second sample 302, as shown in FIG. 8. In this case, the observation apparatus 100 images the third sample 303 using, for example, the first image acquisition unit 150a of the first unit 111 and the second image acquisition unit 150b of the second unit 112. Specifically, the first image acquisition unit 150a scans a half of a region where the third sample 303 is placed, and the second image acquisition unit 150b scans a remaining half of the region where the third sample 303 is placed. At this time, the first image acquisition unit 150a and the second image acquisition unit 150b move almost in the same direction so as not to collide with each other, as shown in FIG. 8. Specifically, the first image acquisition unit 150a and the second image acquisition unit 150b move so that one follows the other. Thus, a limitation depending on the number of samples is imposed on the movement pattern of the image acquisition unit 150. Furthermore, the movement pattern of the image acquisition unit 150 depends on the relationship between a size of the third sample 303 and sizes of the first image acquisition unit 150a and the second image acquisition unit 150b. If the third sample 303 is sufficiently larger than the first image acquisition unit 150a and the second image acquisition unit 150b, in other words, the first support section 158a and the second support section 158b, the first image acquisition unit 150a and the second image acquisition unit 150b can share the imaging as shown in FIG. 8. However, if the third sample. 303 is relatively small, the first image acquisition unit 150a and the second image acquisition unit 150b may not cooperate with each other. The movement pattern of the image acquisition unit 150 also depends on the shape or the like of the third sample 303 and the shapes or the like of the first image acquisition unit 150a and the second image acquisition unit 150b.

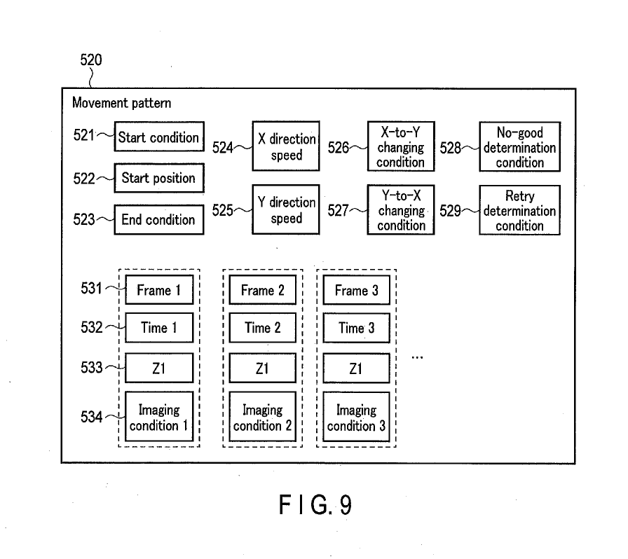

The movement pattern of the imaging section 152 necessary for scanning is stored in, for example, the observation-side storage circuit 123. Specifically, the movement pattern of the first image acquisition unit 150a is stored in the first storage circuit 123a, and the movement pattern of the second image acquisition unit 150b is stored in the second storage circuit 123b. FIG. 9 shows an example of the movement pattern 520 stored in the observation-side storage circuit 123.

The movement pattern 520 includes a start condition 521, a start position 522, and an end condition 523. The start condition 521 includes information on a condition to start a scan. The start condition 521 includes, for example, a time period from a time when the imaging section 152 is set at an initial position to a time when the scan starts. The start position 522 includes information on a position where the scan starts. The start position 522 includes information on, for example, a position of an edge of the transparent plate 102, a position of an edge of the sample 300, etc. The end condition 523 includes information on a condition to end the scan. The end condition 523 includes information on, for example, an end position where the scan ends, and a time period from a scan start time to a scan end time.

The movement pattern 520 further includes an X direction speed 524, a Y direction speed 525, an X-to-Y changing condition 526, and a Y-to-X changing condition 527. The X direction speed 524 includes information on a moving speed of moving the imaging section 152 in the X-axis direction. The Y direction speed 525 includes information on a moving speed of moving the imaging section 152 in the Y-axis direction. The X-to-Y changing condition 526 includes a condition for changing the direction of movement of the imaging section 152 from the X-axis direction to the Y-axis direction. The X-to-Y changing condition 526 includes position information on an edge of a scan region in the X-axis direction. The X-to-Y changing condition 526 may include, for example, information on a movement distance in the X-axis direction for one movement in the X-axis direction. The Y-to-X changing condition 527 includes a condition for changing the direction of movement of the imaging section 152 from the Y-axis direction to the X-axis direction. The Y-to-X changing condition 527 may include, for example, information on a movement distance in the Y-axis direction for one movement in the Y-axis direction.

Furthermore, the movement pattern 520 includes a no-good determination condition 528 and a retry determination condition 529. The no-good determination condition 528 includes a condition of determining that the scan is defective. The retry determination condition 529 includes a condition for determining that the scan should be performed again from the start. The movement pattern 520 may include information on a combination of a frame number 531, imaging time 532 for the frame, a Z coordinate 533, and an imaging condition 534.

The movement pattern 520 is appropriately prepared depending on the number of samples, the sizes of samples, and the shape and size of the image acquisition unit 150.

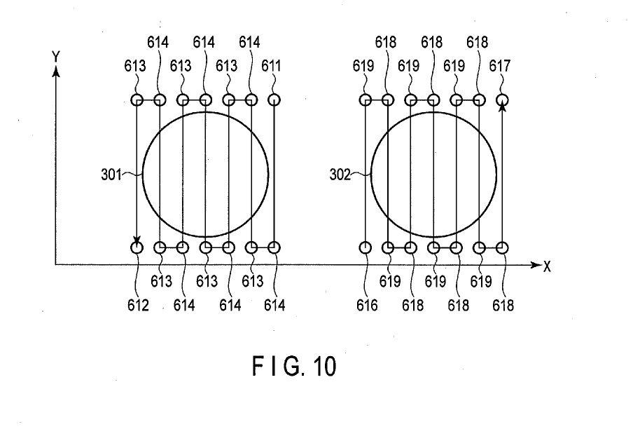

FIG. 10 schematically shows a state of movement of the first imaging section 152a and the second imaging section 152b in the case of two samples. The first imaging section 152a moves from start coordinates 611 to end coordinates 612 for the first sample 301. Therefore, the start position 522 of the movement pattern 520 stored in the first storage circuit 123a includes information on the start coordinates 611, and the end condition 523 of the movement pattern 520 includes information on the end coordinates 612. At first change coordinates 613, movement along the X coordinate is changed to movement along the Y coordinate. Therefore, the X-to-Y changing condition 526 of the movement pattern 520 stored in the first storage circuit 123a includes information on the first change coordinates 613. The first change coordinates 613 may be represented as, for example, a movement distance from the start coordinates 611. At second change coordinates 614, movement along the Y coordinate is changed to movement along the X coordinate. Therefore, the Y-to-X changing condition 527 of the movement pattern 520 stored in the first storage circuit 123a includes information on the second change coordinates 614.

The second imaging section 152b moves from start coordinates 616 to end coordinates 617 for the second sample 302. Therefore, the start position 522 of the movement pattern 520 stored in the second storage circuit 123b includes information on the start coordinates 616, and the end condition 523 of the movement pattern 520 includes information on the end coordinates 617. At third change coordinates 618, movement along the X coordinate is changed to movement along the Y coordinate. Therefore, the X-to-Y changing condition 526 of the movement pattern 520 stored in the second storage circuit 123b includes information on the third change coordinates 618. At fourth change coordinates 619, movement along the Y coordinate is changed to movement along the X coordinate. Therefore, the Y-to-X changing condition 527 of the movement pattern 520 stored in the second storage circuit 123b includes information on the fourth change coordinates 619.

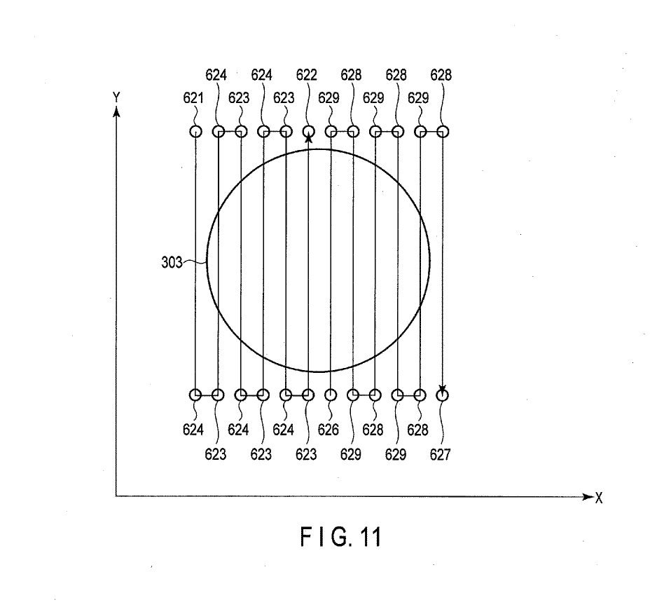

FIG. 11 schematically shows a state of movement of the first imaging section 152a and the second imaging section 152b in the case of one sample. The first imaging section 152a moves from start coordinates 621 to end coordinates 622 for the third sample 303. Therefore, the start position 522 of the movement pattern 520 stored in the first storage circuit 123a includes information on the start coordinates 621, and the end condition 523 of the movement pattern 520 includes information on the end coordinates 622. At first change coordinates 623, movement along the X coordinate is changed to movement along the Y coordinate. Therefore, the X-to-Y changing condition 526 of the movement pattern 520 stored in the first storage circuit 123a includes information on the first change coordinates 623. At second change coordinates 624, movement along the Y coordinate is changed to movement along the X coordinate. Therefore, the Y-to-X changing condition 527 of the movement pattern 520 stored in the first storage circuit 123a includes information on the second change coordinates 624.

Similarly, the second imaging section 152b moves from start coordinates 626 to end coordinates 627 for the third sample 303. Therefore, the start position 522 of the movement pattern 520 stored in the second storage circuit 123b includes information on the start coordinates 626, and the end condition 523 of the movement pattern 520 includes information on the end coordinates 627. At third change coordinates 628, movement along the X coordinate is changed to movement along the Y coordinate. Therefore, the X-to-Y changing condition 526 of the movement pattern 520 stored in the second storage circuit 123b includes information on the third change coordinates 628. At fourth change coordinates 629, movement along the Y coordinate is changed to movement along the X coordinate. Therefore, the Y-to-X changing condition 527 of the movement pattern 520 stored in the second storage circuit 123b includes information on the fourth change coordinates 629.

A plurality of movement patterns 520 as described above are prepared in accordance with kinds of samples, the number of samples, the position where the samples are placed, etc. The controller-side control circuit 210 of the controller 200 transmits information on the movement pattern 520 to be used to the observation apparatus 100 together with instructions to scan. Upon receipt of the instructions to scan from the controller 200, the first control circuit 121a of the first unit 111 reads the movement pattern 520 for the first unit 111 stored in the first storage circuit 123a, and sets the movement pattern. Similarly, upon receipt of the instructions to scan from the controller 200, the second control circuit 121b of the second unit 112 reads the movement pattern 520 for the first unit 111 stored in the first storage circuit 123a, and sets the movement pattern.

The position control section 131 moves the support section 158 provided with the imaging section 152 using information, such as the X direction speed 524, the Y direction speed 525, the X-to-Y changing condition. 526, and the Y-to-X changing condition 527. The imaging control section 132 controls operations of the imaging section 152 using information, such as the Z coordinate 533 and the imaging condition 534. The image processing circuit 122 may analyze an image obtained by imaging, using the frame number 531, the imaging time 532, the X direction speed 524, the Y direction speed 525, the X-to-Y changing condition 526, the Y-to-X changing condition 527, and the Z coordinate 533.

In the example described above, the movement pattern 520 is stored in the observation-side storage circuit 123. However, the movement pattern 520 may be stored in the controller-side storage circuit 230 of the controller 200. In this case, the observation apparatus 100 may be operated by transmission of the movement pattern 520 from the controller 200 to the observation apparatus 100.

Referring back to FIG. 4A, explanations of the control processing performed by the controller will be continued. After step S109, the processing advances to step S110. In step S110, the controller-side control circuit 210 determines whether or not information should be transmitted to the observation apparatus 100. For example, when various settings are determined in step S109, the controller 200 transmits specifics of the settings to the observation apparatus 100. In such a case, the controller-side control circuit 210 determines that information should be transmitted. Furthermore, the controller-side control circuit 210 determines whether or not the user is requesting transmission of information to the observation apparatus 100. For example, if an instruction to transmit information is supplied from the input device 274, the controller-side control circuit 210 determines that the user is requesting transmission of information. The information the transmission of which is requested is information on measurement conditions etc. If the user is requesting transmission of information, the controller-side control circuit 210 determines that the information should be transmitted. If the information is not transmitted, the processing advances to step S112. If the information is transmitted, the processing advances to step S111. In step S111, the controller-side control circuit 210 transmits the information to the observation apparatus 100. Subsequently, the processing advances to step S112.

In step S112, the controller-side control circuit 210 determines whether or not the user manually designates a position to be imaged by the observation apparatus 100. For example, if an imaging position is entered from the input device 274, the controller-side control circuit 210 determines that an imaging position has been designated. If the imaging position is not designated, the processing advances to step S114. If the imaging position is designated, the processing advances to step S113.

In step S113, the controller-side control circuit 210 transmits the imaging position entered from the input device 274 to the observation apparatus 100. For example, it is assumed that a position of either the first image acquisition unit 150a or the second image acquisition unit 150b is designated. At this time, the controller-side control circuit 210 transmits to the observation apparatus 100 the information on the position of the designated one of the image acquisition units. At the same time, the controller-side control circuit 210 checks the positions of the designated image acquisition unit and the other image acquisition unit that is not designated, and determines whether or not the two image acquisition units collide with each other. If the controller-side control circuit 210 determines that they collide, it transmits collision avoidance information to instruct the position of the other image acquisition unit, which is not designated, so that the two do not collide. Subsequently, the processing advances to step S114.

In step S114, the controller-side control circuit 210 determines whether or not the user is requesting that the observation apparatus 100 start measurement. For example, if an instruction to start measurement by the observation apparatus 100 is supplied from the input device 274, the controller-side control circuit 210 determines that the user is requesting the start of measurement. If the start of measurement is not requested, the processing advances to step S116. If the start of measurement is requested, the processing advances to step S115. In step S115, the controller-side control circuit 210 transmits an instruction to start measurement to the observation apparatus 100. Subsequently, the processing advances to step S116.

In step S116, the controller-side control circuit 210 determines whether or not the user is requesting acquisition of information from the observation apparatus 100. For example, if an instruction to request information is supplied from the input device 274, the controller-side control circuit 210 determines that the user is requesting information. The information requested then is, for example, information on the sample 300 obtained by the observation apparatus 100. The information can be information contained in the measurement results, including image data on the sample 300 and the number of cells or cell groups in the sample 300. If the information is not requested, the processing advances to step S118. If the information is requested, the processing advances to step S117. In step S117, the controller-side control circuit 210 transmits an instruction to transmit the user's requested information to the observation apparatus 100. Then, the processing advances to step S118.

In step S118, the controller-side control circuit 210 determines whether or not the information requested in step S117 is received. If the information is not received, the processing advances to step S120. If the information is received, the processing advances to step S119. In step S119, the controller-side control circuit 210 displays the received information on the display device 272 or records it in the controller-side storage circuit 230. Subsequently, the processing advances to step S120.

In step S120, the controller-side control circuit 210 determines whether or not the user is requesting that the power of the observation apparatus 100 be turned off. For example, if an instruction to turn off the power of the observation apparatus 100 is supplied from the input device 274, the controller-side control circuit 210 determines that the user is requesting that the power be turned off. If the instruction to turn off the power is not supplied, the processing advances to step S122. If the instruction to turn off the power is supplied, the processing advances to step S121. In step S121, the controller-side control circuit 210 transmits to the observation apparatus 100 an instruction to turn off the power of the observation apparatus 100. Subsequently, the processing advances to step S122.

In step S122, the controller-side control circuit 210 determines whether or not the measurement program comes to an end. If the measurement program ends, the processing returns to step S101. If the measurement program does not end, the processing returns to step S103. As can be seen from this, the above operation is repeatedly executed.

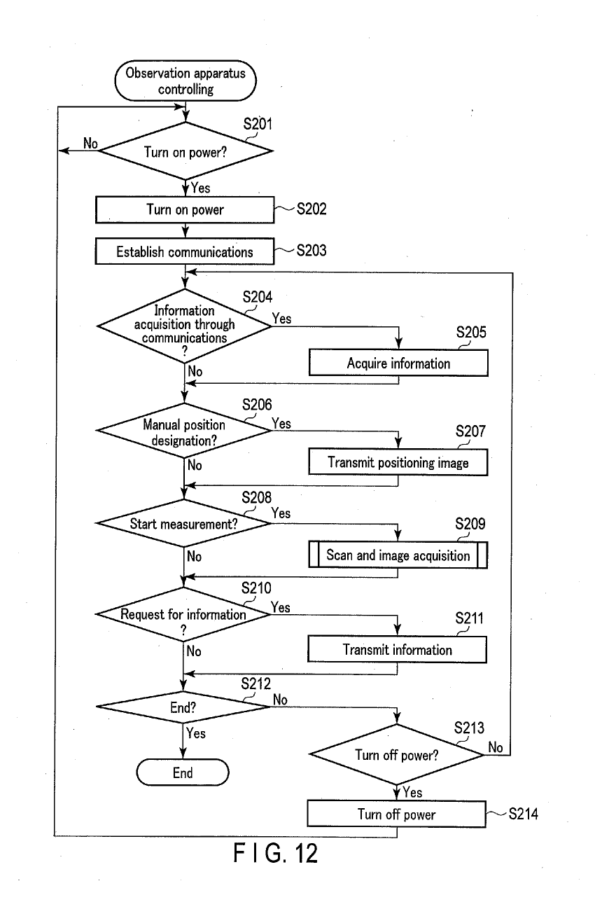

Next, operations of the observation apparatus 100, corresponding to the operations of the aforementioned controller 200, will be described with reference to the flowchart shown in FIG. 12. The processing of the flowchart shown in FIG. 12 starts when the observation apparatus 100, the controller 200, and the sample 300 are in place and preparations for measurement have been made. Similar processing is performed individually in each of the observation-side control circuit 121 of the first unit 111 and the observation-side control circuit 121 of the second unit 112.

In step S201, the observation-side control circuit 121 determines whether or not the power should be turned on. The observation-side control circuit 121 is configured to be turned on at predetermined times, for example. If the time to turn on the power comes, the observation-side control circuit 121 determines that the power should be turned on. Where the observation apparatus 100 constantly communicates with the controller 200 through low-power-consumption communication means such as Bluetooth Low Energy, and when the observation apparatus 100 receives instructions to turn on the power from the controller 200 through the communication means, it is determined that the power should be turned on. This operation corresponds to, for example, the processing in step S104 of the control processing performed by the controller. If the power should not be turned on, the processing stands by, repeating step S201. If it is determined that the power should be turned on, the processing advances to step S202.

In step S202, the observation-side control circuit 121 turns on the power source to supply power to each portion of the observation apparatus 100. If the power is turned on only when the sample 300 is actually measured, power saving can be attained. In particular, if the power source of the observation apparatus 100 is a battery, advantages can be obtained, for example, the driving time of the observation apparatus 100 can be lengthened.

In step S203, the observation-side control circuit 121 establishes communications with the controller 200. The communication means used in the embodiment is high-speed communication means, such as Wi-Fi.

In step S204, the observation-side control circuit 121 determines whether or not information should be acquired from the controller 200 through the established communications. For example, when information is transmitted from the controller 200 in step S111 of the control processing performed by the controller, it is determined that the information should be acquired. If the information is not acquired, the processing advances to step S206. If the information is acquired, the processing advances to step S205.

In step S205, the observation-side control circuit 121 acquires the information transmitted from the controller 200. The acquired information includes condition information, such as measurement conditions (including imaging conditions, imaging intervals, information to specify a movement pattern, and other parameters), a method for recording measurements, a transmission condition for the measurements, etc. Subsequently, the processing advances to step S206.

In step S206, the observation-side control circuit 121 determines whether or not manual position designation is performed. In other words, it is determined whether an imaging instruction is received from the controller 200 with designation of an imaging position. The processing corresponds to, for example, step S113 of the control processing performed by the controller. If an imaging instruction is not received, the processing advances to step S208. If an imaging instruction is received, the processing advances to step S207.

In step S207, the observation-side control circuit 121 causes the driving mechanism 140 to move the imaging section 152 to a designated position and causes the imaging section 152 to acquire an image at that position. At this time, if collision avoidance information is received from the controller 200, the observation-side control circuit 121 causes the driving mechanism 140 to operate based on the collision avoidance information. In the operation for collision avoidance, the moving speed may be set to be higher than those in the other cases. The observation-side control circuit 121 transmits the acquired image to the controller 200 by way of the observation-side communication device 124. Subsequently, the processing advances to step S208.

In step S208, the observation-side control circuit 121 determines whether or not the current time is a time when the measurement should be started. If the current time is not a measurement start time, the processing advances to step S210. If the current time is a measurement start time, the processing advances to step S209. The measurement start time may be predetermined, for example, at the intervals of one hour. The measurement start condition need not depend on time but may depend on the state of the cell 324 or culture medium 322. In the present embodiment, measurement is repeatedly performed whenever the measurement start time comes.

In step S209, the observation-side control circuit 121 performs measurement through the scan and image acquisition processing. In other words, the observation-side control circuit 121 causes the imaging section 152 to repeatedly perform imaging, while simultaneously causing the driving mechanism 140 to move the imaging section 152. The first control section 110 performs predetermined processing for an obtained image and records a requested result in the observation-side storage circuit 123.

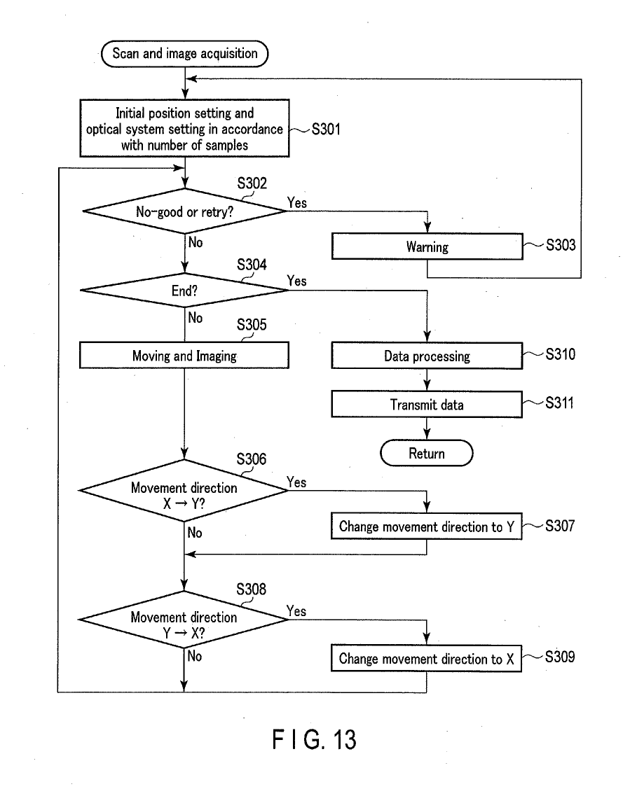

Details of the scan and image acquisition processing will be described with reference to the flowchart shown in FIG. 13.

In step S301, the observation-side control circuit 121 performs various settings, such as setting of an initial position and setting of the optical systems, in accordance with the number of samples. Specifically, the observation-side control circuit 121 controls operations of the driving mechanism 140 so that the imaging section 152 moves to the initial position based on the movement pattern 520. Furthermore, the observation-side control circuit 121 makes predetermined setting for the imaging optical system 153.

The aforementioned phrase “in accordance with the number of samples” may be replaced by “in accordance with a characteristic of a sample”. For example, “a characteristic of a sample” may be whether or not the sample is discrete. The characteristic of a sample may be anything that can be a reason to determine whether a plurality of image acquisition units 150 should move in cooperation or independently. When the image acquisition units 150 move in cooperation, estimation or ascertainment of a relative position or subsequent movement must be made for control to avoid a collision or interference between the image acquisition units 150. When the image acquisition units 150 move independently, if territories (region assignments or assigned regions) of the respective image acquisition units 150 are determined, detailed estimates or the like can be eliminated as long as the units maintain their respective territories.

The image acquisition units 150 move in cooperation in the following cases: a case of repeatedly acquiring images at short intervals while scanning the same sample; a case of acquiring images using the image acquisition units 150 having different image acquisition characteristics (optical characteristics such as a wavelength or phase, imaging characteristics such as an angular field or resolution); a case of acquiring a distance or three-dimensional information based on determination results at a plurality of positions; and a case where a plurality of observers or operators customize their respective image acquisition units 150 and respectively operate the image acquisition units 150 to observe one sample.

The image acquisition units 150 may not move in cooperation if they make no or little movement from the respective current positions. There is a case in which a plurality of image acquisition units are not necessary. In such a case, for example, one is moved freely and the others retreated. Thus, depending on conditions, a scheme for preventing the image acquisition units 150 from positionally interfering with one another becomes necessary.

The aforementioned phrase “in accordance with a characteristic of a sample” may include the following case. For example, in the case of repeatedly acquiring images at short intervals while scanning the same sample, cooperation may be unnecessary if the sample does not change at all. However, if the sample changes greatly, cooperation may be necessary. Furthermore, the image acquisition units 150 may need to cooperate, if the sample expands with time. Thus, the phrase “in accordance with a characteristic of a sample” may include cases in view of time-varying properties of various samples. Since a change of observers etc. may depend on circumstances of a laboratory where the observation is made or situations at that time, the aforementioned phrase “the number of samples” may be replaced by “observation conditions”.

In step S302, the observation-side control circuit 121 determines whether or not a defect occurs in imaging by the imaging section 152 or in movement by the driving mechanism 140. If a defect occurs in imaging or movement, the processing advances to step S303.

In step S303, the observation-side control circuit 121 notifies and warns the user that a defect occurs in imaging or movement. Specifically, the observation-side control circuit 121 transmits the information that a defect occurs to the controller 200. Subsequently, the processing returns to step S301. In this case, the processes from the step S301 may be repeated. Alternatively, if a defect continuously occurs a predetermined times, the scan and image acquisition processing may be ended.

If it is determined in step S303 that no defect occurs in imaging or movement, the process advances to step S304. In step S304, the observation-side control circuit 121 determines whether or not the scan and image acquisition processing should be ended. For example, if the end condition 523 included in the movement pattern 520 is satisfied, it is determined that the processing should be ended. If it is determined that the processing should not be ended, the processing advances to step S305.

In step S305, the observation-side control circuit 121 causes the image acquisition unit 150 to move, and causes the imaging section 152 to perform an imaging operation to acquire an image. Image data is obtained by the imaging operation. The obtained image is provisionally stored in the observation-side storage circuit 123. Subsequently, the processing advances to step S306.

In step S306, the observation-side control circuit 121 determines whether or not the direction of movement should be changed from the X-axis direction to the Y-axis direction with reference to the X-to-Y changing condition 526. If the direction of movement is not changed, the processing advances to step S308. If the direction of movement is changed, the processing advances to step S307. In step S307, the observation-side control circuit 121 causes the driving mechanism 140 to change setting of the direction of movement of the imaging section 152 to be performed next. Subsequently, the processing advances to step S308.

In step S308, the observation-side control circuit 121 determines whether or not the direction of movement should be changed from the Y-axis direction to the X-axis direction with reference to the Y-to-X changing condition 527. If the direction of movement should not be changed, the processing returns to step S302. If the direction of movement should be changed, the processing advances to step S309. In step S309, the observation-side control circuit 121 causes the driving mechanism 140 to change setting of the direction of movement of the imaging section 152 to be performed next. Subsequently, the processing returns to step S302.

As described above, the image acquisition unit 150 moves based on the movement pattern 520 and repeats imaging until the processing is determined to be ended.

In step S304, if the processing is determined to be ended, the processing advances to step S310. In step S310, the observation-side control circuit 121 performs processing of data obtained by repeated imaging. The observation-side control circuit 121 produces a synthesis image of the overall sample based on, for example, the obtained image. Furthermore, the observation-side control circuit 121 analyzes a position of the sample 300, and positions and the number of cells 324 contained in the sample 300. The observation-side control circuit 121 also produces data suitable for transmission to, for example, the controller 200. In a case where an image of the sample 300 and the number and positions of cells 324 contained in the sample 300 are analyzed by means of the controller 200, the observation-side control circuit 121 may not analyze them.

In step S311, the observation-side control circuit 121 transmits the image, the synthesis image, and the analysis results obtained through continuous imaging by the imaging section 152 to the controller 200. The images may be collectively transmitted in step S311, or may be sequentially transmitted in any step, for example, step S305, in the repeated processing in step S302 to step S309. The scan and image acquisition processing is ended through the aforementioned steps, and the processing returns to the observation apparatus control processing.

Referring back to FIG. 12, the description will be continued. After the scan and image acquisition processing in step S209, the processing advances to step S210.

In step S210, the observation-side control circuit 121 determines whether or not a request for information is made by the controller 200. For example, the data obtained in step S209 is requested by the controller 200, for example, through the process in step S117 of the control processing performed by the controller. If there is no request for information, the processing advances to step S212. If there is a request for information, the processing advances to step S211.

In step S211, the observation-side control circuit 121 transmits the information requested by the controller 200 through the observation-side communication device 124 to the controller 200. As a result, the information is acquired by the controller 200 in step S119 of the control processing performed by the controller, and the controller 200 displays or records the information. Subsequently, the processing advances to step S212.

In step S212, the observation-side control circuit 121 determines whether or not the observation apparatus control processing should be ended. If it is determined that the observation apparatus control processing should be ended, the observation apparatus control processing is brought to an end. For example, when a series of measurements are ended and the observation apparatus 100 is removed from the incubator, the observation apparatus control processing is brought to an end. If the observation apparatus control processing is not brought to an end, the processing advances to step S213.

In step S213, the observation-side control circuit 121 determines whether or not the power should be turned off. For example, if the standby time, which is from the measurement in step S209 to the next measurement, is long, the observation-side control circuit 121 determines that the power should be turned off to suppress the power consumption. When an instruction to turn off the power is transmitted in step S121 of the control processing performed by the controller, the observation-side control circuit 121 which receives the instruction determines that the power should be turned off. If the power should not be turned off, the processing returns to step S204. If it is determined that the power should be turned off, the processing advances to step S214.

In step S214, the observation-side control circuit 121 turns off each portion of:the observation apparatus 100. Subsequently, the processing returns to step S201. In the above manner, the observation apparatus 100 repeatedly performs measurement.

### <Advantage of Observation System>

The observation system 1 of the present embodiment can obtain images of cells existing in the state where the sample 300 is statically placed in the incubator. It should be noted that an image can be repeatedly obtained with time. The user can therefore observe how the cells change with time and analyze the change. The observation system 1 of this embodiment is provided with the two image acquisition units 150. Because of the provision of the two image acquisition units 150, two samples can be simultaneously imaged. Furthermore, because of the provision of the two image acquisition units 150, images in a wider range can be acquired more quickly than in the case of one image acquisition unit.

The movement pattern of the image acquisition unit 150 is selected based on characteristics of samples, such as the number of samples to be measured. For simplicity, the above explanations were given on the assumption that different patterns are prepared for the case of one sample and for the case of two samples. Since movements of the two image acquisition units 150 are controlled using the movement patterns, the observation apparatus 100 can acquire appropriate images by means of the two image acquisition units 150. Moreover, since the movement patterns that enable efficient image acquisition are prepared, the two image acquisition units 150 of course do not collide with each other.

If one of the two image acquisition units 150 is designated by the user, and if the other image acquisition unit moves in accordance with the movement pattern prepared in advance, the two image acquisition units 150 may collide with each other. Therefore, if one of the two image acquisition units 150 is designated by the user, the other image acquisition unit 150 can perform an operation for collision avoidance as needed, so that collision can be avoided.

The characteristic of samples in the case described above is not necessarily the number of vessels, such as petri dishes or culture flasks. For example, cell groups separated from each other in the same petri dish are considered different samples. In other words, the characteristic of a sample may be whether or not the sample is discrete or not. Thus, the characteristic of a sample may be anything that can be a reason to determine whether a plurality of image acquisition units 150 should move in cooperation or independently. When the image acquisition units 150 move in cooperation, estimation or ascertainment of a relative position or subsequent movement must be made for adjustment to avoid a collision or interference between the image acquisition units 150. When the image acquisition units 150 move independently, if territories (region assignments or assigned regions) of the respective image acquisition units 150 are determined, detailed estimates or the like of positions or movements can be eliminated as long as the image acquisition units 150 moves in accordance with their respective territories. The image acquisition units 150 move in cooperation, for example, in the following cases: a case of repeatedly acquiring images at short intervals while scanning the same sample; a case of acquiring images using both the image acquisition units 150 having different image acquisition characteristics (optical characteristics such as a wavelength and phase, imaging characteristics such as an angular field and resolution); a case of acquiring a distance or three-dimensional information based on determinations at a plurality of positions; and a case where a plurality of observers or operators customize their respective image acquisition units 150 and respectively operate the image acquisition units 150 to observe one sample. The image acquisition units may not move in cooperation in the following cases: a case where at least one of the image acquisition units 150 make no or little movement from the respective current positions; and a case where only one of a plurality of image acquisition units is necessary, in which case one is moved freely and the others retreated. Thus, depending on conditions, a scheme for preventing the image acquisition units 150 from positionally interfering with one another becomes necessary.

Determinations or programs as described above may employ results of machine learning as needed. If a plurality of operators cause artificial intelligence to learn ordinary settings or processes and results of mutual concessions or the like made through negotiations, cooperation under various situations can be smoothly performed.

In the above case of the first embodiment described above, the first unit 111 and the second unit 112 independently operate, for example. However, the embodiment is not limited to the above case. The first unit 111 and the second unit 112 of the observation apparatus 100 may be integrally controlled. The control may be performed by a control circuit provided in the casing 101, or may be performed by the controller 200.

### Second Embodiment

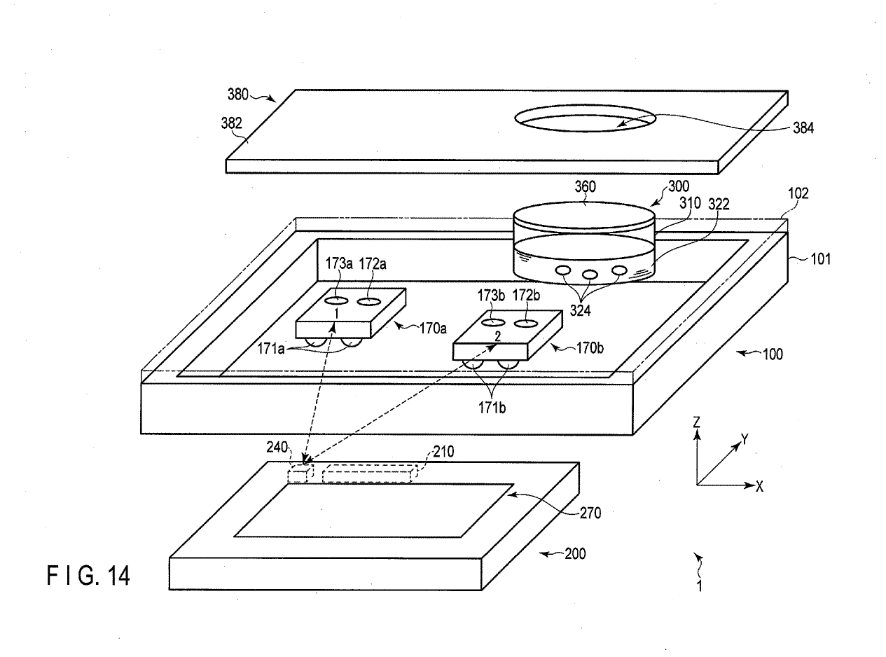

The second embodiment will be explained below. In the following, matters different from the first embodiment will be explained. Identical symbols will be used for identical parts, and detailed explanations thereof will be omitted. An observation apparatus 100 of the second embodiment is provided with a first self-propelled unit 170a and a second self-propelled unit 170b as shown in FIG. 14 instead of the first unit 111 and the second unit 112 of the first embodiment.

The first self-propelled unit 170a has functions of the first unit 111 of the first embodiment. Specifically, the first self-propelled unit 170a comprises a first imaging section 172a and a first illumination section 173a. The first self-propelled unit 170a comprises a first wheel 171a for self-propulsion. The first self-propelled unit 170a comprises various circuits corresponding to the first circuit group 120a of the first embodiment.

Similarly, the second self-propelled unit 170b has the functions of the second unit 112 of the first embodiment. Specifically, the second self-propelled unit 170b comprises a second imaging section 172b and a second illumination section 173b. The second self-propelled unit 170b comprises a second wheel 171b for self-propulsion. The second self-propelled unit 170b comprises various circuits corresponding to the second circuit group 120b of the first embodiment.

The first self-propelled unit 170a and the second self-propelled unit 170b image a sample 300, while they are moving with the first wheel 171a and the second wheel 171b. A plurality of reflection patterns representing position information are drawn on a transparent plate 102 of this embodiment, so that the first self-propelled unit 170a and the second self-propelled unit 170b can acquire their respective current positions.

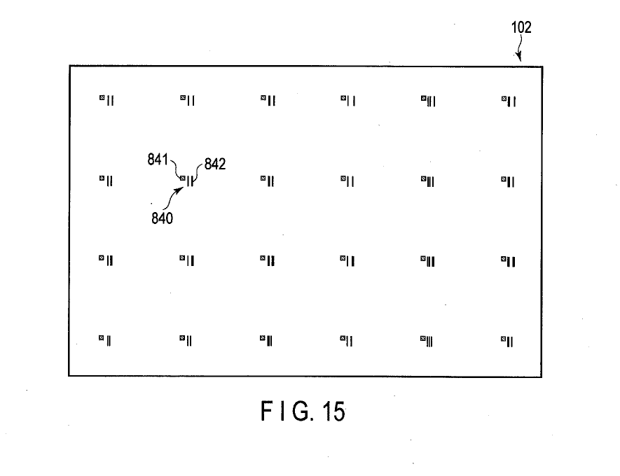

An example of the reflection patterns drawn on the transparent plate 102 will be explained with reference to FIG. 15. In a reflection pattern 840, a plurality of dots 841 are arranged at regular intervals on the transparent plate 102, and, for example, a bar code 842 is arranged near each of the dots 841. The bar codes 842 represent coordinate information of the respective dots 841. Instead of the bar codes 842, two-dimensional codes representing coordinate information of the respective dots 841 may be arranged.

In this embodiment, the first self-propelled unit 170a and the second self-propelled unit 170b move while imaging the reflection pattern 840, analyze the information included in the reflection pattern 840, and acquire the current positions of themselves.

A pattern corresponding to the reflection pattern 840 may be formed on a bottom surface of the casing 101. In this case, the observation apparatus 100 may be configured so that the first self-propelled unit 170a and the second self-propelled unit 170b acquire the current positions of themselves by acquiring an image of the pattern using imaging sections provided separately. Alternatively, the observation apparatus 100 may be configured so that the first self-propelled unit 170a and the second self-propelled unit 170b acquire the current positions of themselves not based on the image, but by a magnetic, radio, optical, or any other method. Furthermore, the first self-propelled unit 170a and the second self-propelled unit 170b may be configured to ascertain their relative positions to avoid collision.

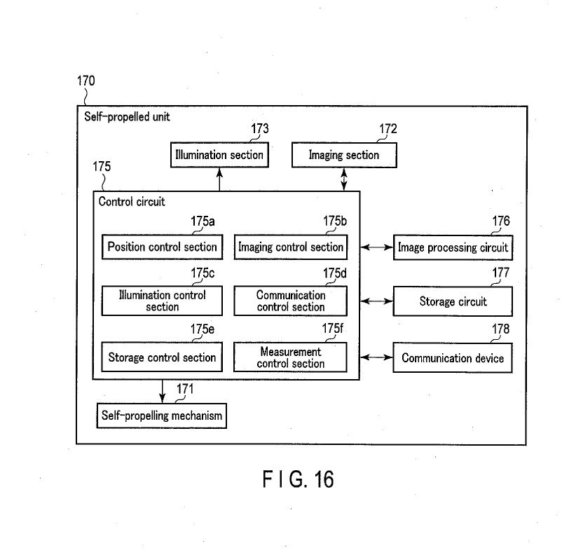

An example of configurations of the first self-propelled unit 170a and the second self-propelled unit 170b will be explained with reference to FIG. 16. Since the first self-propelled unit 170a and the second self-propelled unit 170b are similar in configuration, the configuration will be described as a configuration of a self-propelled unit 170.

The self-propelled unit 170 comprises a self-propelling mechanism 171 including the first wheel 171a or the second wheel 171b, an imaging section 172 including the first imaging section 172a or the second imaging section 172b, and an illumination section 173 including the first illumination section 173a or the second illumination section 173b. The self-propelled unit 170 also comprises a control circuit 175, an image processing circuit 176, a storage circuit 177, and a communication device 178. The control circuit 175 has functions similar to those of the observation-side control circuit 121 of the first embodiment. Accordingly, the control circuit 175 functions as a position control section 175a, an imaging control section 175b, an illumination control section 175c, a communication control section 175d, a storage control section 175e, and a measurement control section 175f. In this embodiment, the position control section 175a controls operations of the self-propelling mechanism 171. The other functions are the same as those of the first embodiment. The image processing circuit 176, the storage circuit 177, and the communication device 178 of this embodiment are respectively similar in configuration and function to the image processing circuit 122, the observation-side storage circuit 123, and the observation-side communication device 124 of the first embodiment.

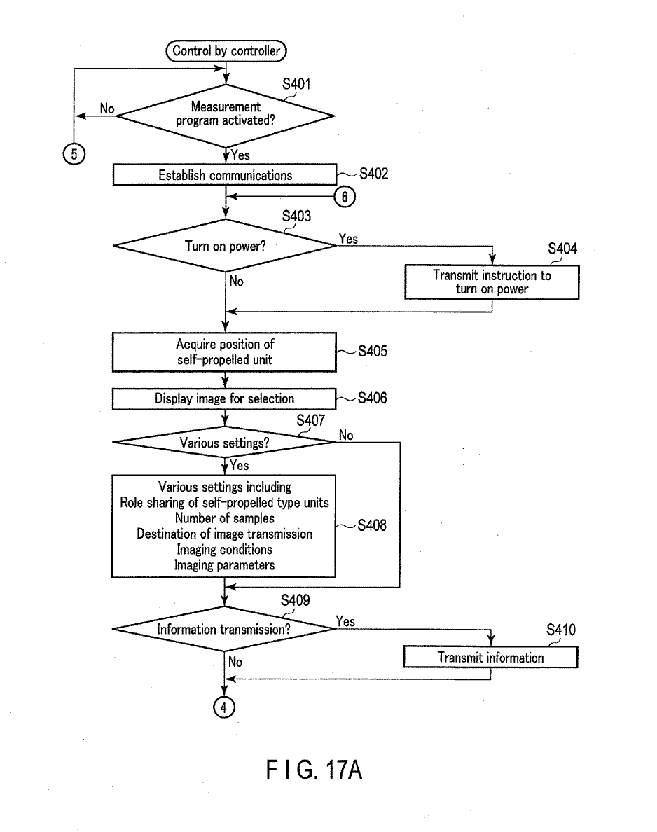

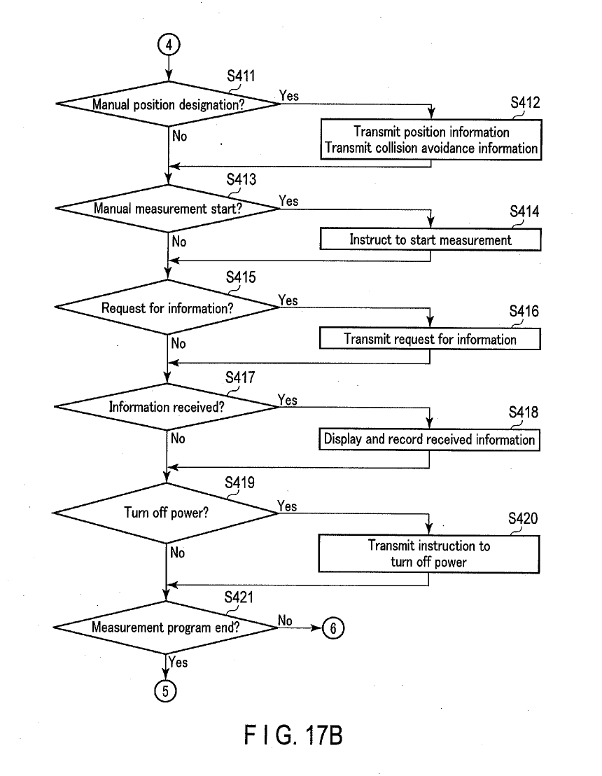

An example of control performed by the controller 200 of this embodiment will be described with reference to the flowcharts shown in FIGS. 17A and 17B.

The processing of step S401 to S404 is the same as the control performed by the controller in step S101 to S104 of the first embodiment. In brief, in step S401, the controller-side control circuit 210 determines whether or not a measurement program according to the present embodiment is activated. If the measurement program is not activated, the processing stands by, repeating step S401. If it is determined that the measurement program is activated, the processing advances to step S402. In step S402, the controller-side control circuit 210 establishes communications with the observation apparatus 100. In step S403, the controller-side control circuit 210 determines whether or not the user is requesting that the power of the observation apparatus 100 be turned on. If the instruction to turn on the power is not supplied, the processing advances to step S405. If the instruction to turn on the power is supplied, the processing advances to step S404. In step S404, the controller-side control circuit 210 transmits to the observation apparatus 100 an instruction to turn on the power of the observation apparatus 100. Subsequently, the processing advances to step S405.

In step S405, the controller-side control circuit 210 acquires a position of each self-propelled unit 170. Namely, the controller-side control circuit 210 receives from the first self-propelled unit 170a information on the position of the first self-propelled unit 170a specified on the basis of the reflection pattern 840. Similarly, the controller-side control circuit 210 receives from the second self-propelled unit 170b information on the position of the second self-propelled unit 170b.

In step S406, the controller-side control circuit 210 causes the display device 272 to display an image for selection for user's input about operations of the observation system 1. The image for selection is, for example, the same as that of the first embodiment. In step S407, the controller-side control circuit 210 determines whether or not various settings are input. If various settings are not input, the processing advances to step S409. If various settings are input, the processing advances to step S408.

In step S408, the controller-side control circuit 210 performs various settings. The settings include, for example, the following. The controller-side control circuit 210 may set role sharing of each self-propelled unit 170. Namely, the controller-side control circuit 210 specifies roles of the first self-propelled unit 170a and the second self-propelled unit 170b based on the number of samples or the like. The controller-side control circuit 210 may also set the number of samples and a movement pattern including an initial position of the self-propelled unit 170 based on the number of samples. Furthermore, the same settings as those of the first embodiment may be made. For example, the controller 200 or another device may be designated as a destination of transmission of an image. Conditions for imaging the sample 300 may also be designated. Furthermore, imaging parameters using the imaging section 152, such as an exposure time, an aperture value, and a focus position, may be designated. A scanning pattern for imaging while scanning the sample 300 may also be designated on the basis of the movement pattern. Other necessary settings may also be set. After step S408, the processing advances to step S409. In this embodiment, the number of samples is noted as an example; however, the phrase “the number of samples” may be replaced by “characteristics of samples” as described above in connection with the first embodiment. Since the setting may depend on observation conditions, the phrase “the number of samples” may be replaced by “observation conditions”.

The processing of step S409 to S421 is the same as the control performed by the controller in step S110 to S122 of the first embodiment. In brief, in step S409, the controller-side control circuit 210 determines whether or not information should be transmitted to the observation apparatus 100. If the information should not be transmitted, the processing advances to step S411. If the information should be transmitted, the processing advances to step S410. In step S410, the controller-side control circuit 210 transmits the information entered from the input device 274 to the observation apparatus 100. Subsequently, the processing advances to step S411.

In step S411, the controller-side control circuit 210 determines whether or not the user manually designates a position to be imaged by the observation apparatus 100. If the imaging position is not designated, the processing advances to step S413. If the imaging position is designated, the processing advances to step S412.

In step S412, the controller-side control circuit 210 transmits the imaging position entered from the input device 274 to the observation apparatus 100. For example, it is assumed that a position of either the first self-propelled unit 170a or the second self-propelled unit 170b is designated. Then, the controller-side control circuit 210 transmits to the observation apparatus 100 the information on the position of the designated one of the units. If the controller-side control circuit 210 determines that the first self-propelled unit 170a and the second self-propelled unit 170b collide, it transmits collision avoidance information to instruct the position of the other self-propelled unit, which is not designated, so that the two do not collide. Subsequently, the processing advances to step S413.

In step S413, the controller-side control circuit 210 determines whether or not the user is requesting that the observation apparatus 100 start measurement. If the start of measurement is not requested, the processing advances to step S415. If the start of measurement is requested, the processing advances to step S414. In step S414, the controller-side control circuit 210 transmits an instruction to start measurement to the observation apparatus 100. Subsequently, the processing advances to step S415.

In step S415, the controller-side control circuit 210 determines whether or not the user is requesting acquisition of information from the observation apparatus 100. If the information is not requested, the processing advances to step S417. If the information is requested, the processing advances to step S416. In step S416, the controller-side control circuit 210 transmits an instruction to transmit the user's requested information to the observation apparatus 100. Subsequently, the processing advances to step S417.

In step S417, the controller-side control circuit 210 determines whether or not the information requested in step S416 is received. If the information is not received, the processing advances to step S419. If the information is received, the processing advances to step S418. In step S418, the controller-side control circuit 210 displays the received information on the display device 272 or records it in the controller-side storage circuit 230. Subsequently, the processing advances to step S419.

In step S419, the controller-side control circuit 210 determines whether or not the user is requesting that the power of the observation apparatus 100 be turned off. If the instruction to turn off the power is not supplied, the processing advances to step S421. If the instruction to turn off the power is supplied, the processing advances to step S420. In step S420, the controller-side control circuit 210 transmits to the observation apparatus 100 an instruction to turn off the power of the observation apparatus 100. Subsequently, the processing advances to step S421.

In step S421, the controller-side control circuit 210 determines whether or not the measurement program comes to an end. If the measurement program ends, the processing returns to step S401. If the measurement program does not end, the processing returns to step S403. Thus, the above operation is repeatedly executed.

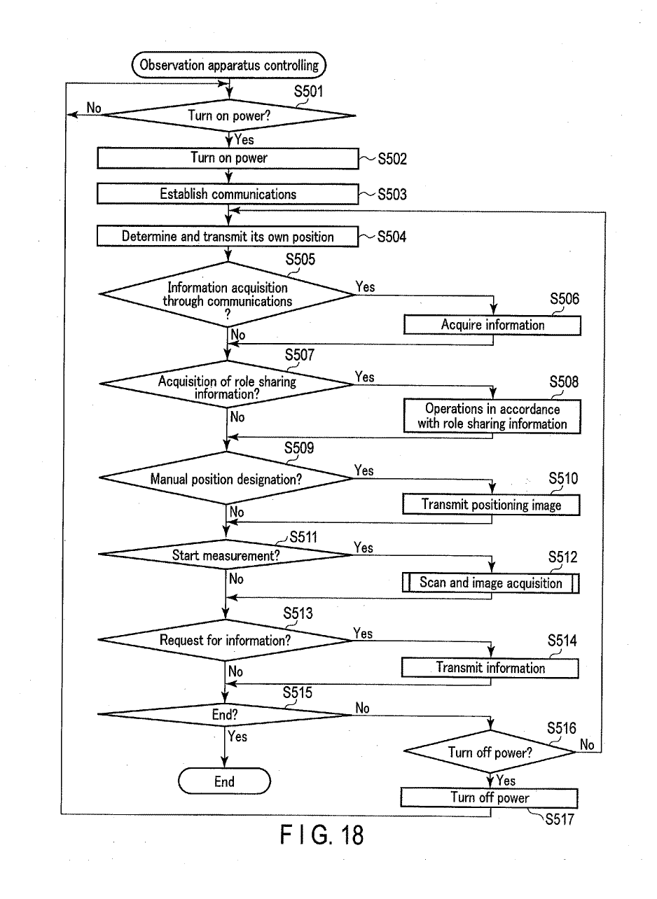

Next, operations of the self-propelled unit 170 of the observation apparatus 100, corresponding to the operations of the aforementioned controller 200, will be described with reference to the flowchart shown in FIG. 18. Operations explained below are performed in each of the first self-propelled unit 170a and the second self-propelled unit 170b.

The processing of step S501 to S503 is the same as the observation apparatus control in step S201 to S203 of the first embodiment. In brief, in step S501, the control circuit 175 determines whether or not the power should be turned on. If the power should not be turned on, the processing stands by, repeating step S501. If it is determined that the power should be turned on, the processing advances to step S502. In step S502, the control circuit 175 turns on the power source to supply power to each portion of the observation apparatus 100. In step S503, the control circuit 175 establishes communications with the controller 200.

In step S504, the control circuit 175 images the reflection pattern 840 formed on the transparent plate 102, and specifies a position of the self-propelled unit 170 based on the reflection pattern 840. The control circuit 175 transmits the position to the controller 200.

In step S505, the control circuit 175 determines whether or not information should be acquired from the controller 200 through the established communications. If the information is not acquired, the processing advances to step S507. If the information is acquired, the processing advances to step S506. In step S506, the control circuit 175 acquires the information transmitted from the controller 200. The acquired information may include information on the movement pattern, condition information, such as measurement conditions (including imaging conditions, imaging intervals, and other parameters), a method for recording measurements, a transmission condition for the measurements, etc. Subsequently, the processing advances to step S507.

In step S507, the control circuit 175 determines whether or not role sharing information should be acquired. For example, when role sharing information set in step S408 of control by the controller 200 is transmitted in step S410, it is determined that the role sharing information should be acquired. If the role sharing information is not acquired, the processing advances to step S509. If the information is acquired, the processing advances to step S508.

In step S508, the control circuit 175 acquires the role sharing information and performs operations in accordance with the acquired role sharing information. Subsequently, the processing advances to step S509.

The processing of step S509 to S514 is the same as the observation apparatus control in step S206 to S214 of the first embodiment. In brief, in step S509, the control circuit 175 determines whether or not manual position designation is performed. The processing corresponds to, for example, step S412 of the control processing performed by the controller. If an imaging instruction is not received, the processing advances to step S511. If an imaging instruction is received, the processing advances to step S510. In step S510, the control circuit 175 causes the self-propelling mechanism 171 to move the imaging section 172 to a designated position and causes the imaging section 172 to acquire an image at that position. At this time, if collision avoidance information is received from the controller 200, the control circuit 175 causes the self-propelling mechanism 171 to operate based on the collision avoidance information. The control circuit 175 transmits the acquired image to the controller 200 by way of the communication device 178. Subsequently, the processing advances to step S511.

In step S511, the control circuit 175 determines whether or not the current time is a time when the measurement should be started. If the current time is not a measurement start time, the processing advances to step S513. If the current time is a measurement start time, the processing advances to step S512. In step S512, the control circuit 175 performs measurement through the scan and image acquisition processing. In other words, the control circuit 175 causes the imaging section 172 to repeatedly perform imaging, while simultaneously causing the self-propelling mechanism 171 to move the imaging section 172. The scan and image acquisition processing is similar to the processing described above with reference to FIG. 13. After the scan and image acquisition processing, the processing advances to step S513.

In step S513, the control circuit 175 determines whether or not there is a request for information from the controller 200. If there is no request for information, the processing advances to step S515. If there is a request for information, the processing advances to step S514. In step S514, the control circuit 175 transmits the information requested by the controller 200 to the controller 200 through the communication device 178. Subsequently, the processing advances to step S515.

In step S515, the control circuit 175 determines whether or not the observation apparatus control processing should be ended. If it is determined that the observation apparatus control processing should be ended, the observation apparatus control processing is brought to an end. If the observation apparatus control processing is not brought to an end, the processing advances to step S516. In step S516, the control circuit 175 determines whether or not the power should be turned off. If the power should not be turned off, the processing returns to step S504. If it is determined that the power should be turned off, the processing advances to step S517. In step S517, the control circuit 175 turns off each portion of the observation apparatus 100. Subsequently, the processing returns to step S501. In the above manner, the self-propelled unit 170 of the observation apparatus 100 repeatedly performs measurement.

The configuration of the observation apparatus 100 including the self-propelled units 170 as in this embodiment is the same in operation and effect as the first embodiment.

In the embodiment described above as an example, the controller 200 controls operations of the first self-propelled unit 170a and the second self-propelled unit 170b of the observation apparatus 100. However, the embodiment is not limited to this example. The first self-propelled unit 170a and the second self-propelled unit 170b may communicate, and may partly bear the processing performed by the controller 200 described above.

### Third Embodiment

The third embodiment is explained below. In the following, matters different from the first and second embodiments will be explained. Identical symbols will be used for identical parts, and detailed explanations thereof will be omitted. In the first and second embodiments, the number of imaging sections is two. However, the number of imaging sections is not limited to two, but may be more than two. Furthermore, in the first and second embodiments, the observation apparatus 100 and the controller 200 are separate from each other, and bear the predetermined functions described above. However, the observation apparatus 100 and the controller 200 may share functions in any other way. In other words, the functions allocated to the observation apparatus 100 in the first and second embodiments may be partly allocated to the controller 200, or vice versa. What is required in practice is merely that the observation system 1 as a whole has the functions described above.

As in the first or second embodiment, the observation system 1 includes a plurality of imaging sections to image a sample that cooperate each other. Thus, it is necessary to devise a scheme relating to an observation method using an observation system that includes a plurality of driving mechanisms for moving each of the imaging sections to change an imaging position relative to a sample. The observation method includes a step of determining a characteristic of the sample. Based on the characteristic of the sample, images in accordance with conditions can be effectively acquired without interfering with movements of a plurality of imaging sections. Therefore, it is important that the observation method includes a step of determining movement patterns of the respective imaging sections. The observation method includes a step of controlling operations of the driving mechanisms and imaging sections to cause the imaging sections to individually perform imaging, while causing the driving mechanisms to move the respective imaging sections in accordance with the determined movement patterns. Thus, the observation system and observation method described herein allow efficient observation in which the imaging sections do not interfere with each other's movement and observation as much as possible but effectively cooperate with each other, depending on conditions of samples, the number of samples, observers, the number of observers, and conditions of observation. If necessary, a system for machine learning using a dedicated device may be prepared, and results of the machine learning may be employed in the control of movement in the observation system or the observation method. To realize such a system, a plurality of operators may cause artificial intelligence to learn ordinary settings, orders of operations of the respective operators determined through negotiations, or processes and results of mutual concessions or the like. As a result of the machine learning, the observation system gives an advice in advance or executes operations, so that cooperation under various situations can be smoothly performed.

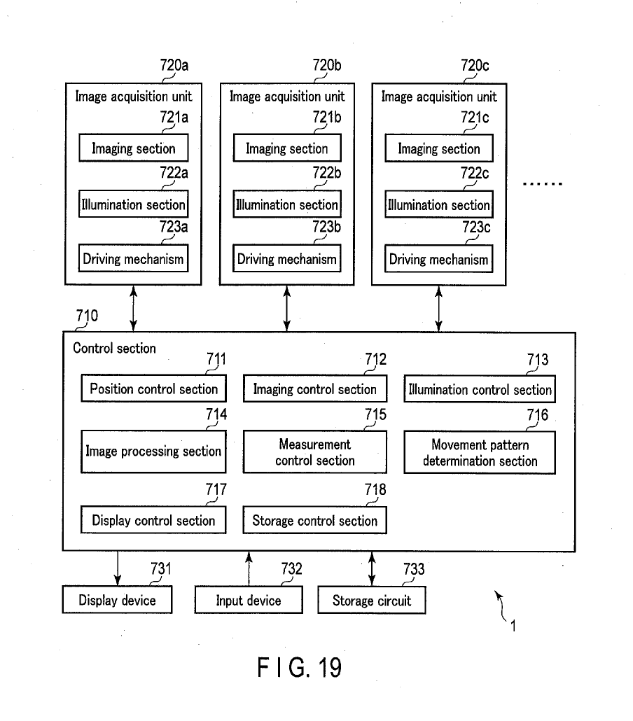

The observation system 1 as a whole may have functions as shown in FIG. 19. Specifically, the observation system 1 comprises a plurality of image acquisition units 720a, 720b, 720c, and so on. The image acquisition units respectively comprise imaging sections 721a, 721b, 721c, and so on. Furthermore, the image acquisition units respectively comprise illumination sections 722a, 722b, 722c, and so on. Furthermore, the image acquisition units respectively comprise driving mechanisms 723a, 723b, 723c, and so on.

The observation system 1 comprises a control section 710. The control section 710 functions as a position control section 711, an imaging control section 712, an illumination control section 713, an image processing section 714, a measurement control section 715, a movement pattern determination section 716, a display control section 717, and a storage control section 718. These functions may be implemented by one device, or may be shared by a plurality of devices, for example, an observation apparatus and a controller. What is required is merely that those functions are implemented by the observation system 1 as a whole. At least a part of the functions of the control section 710 may be implemented by a plurality of controllers. For example, a plurality of operators may operate the image acquisition units by respectively operating the controllers. In this case, a plurality of users can simultaneously observe the same or different samples by one observation apparatus based on their respective interests. The observation system 1 comprises a display device 731, an input device 732, and a storage circuit 733.

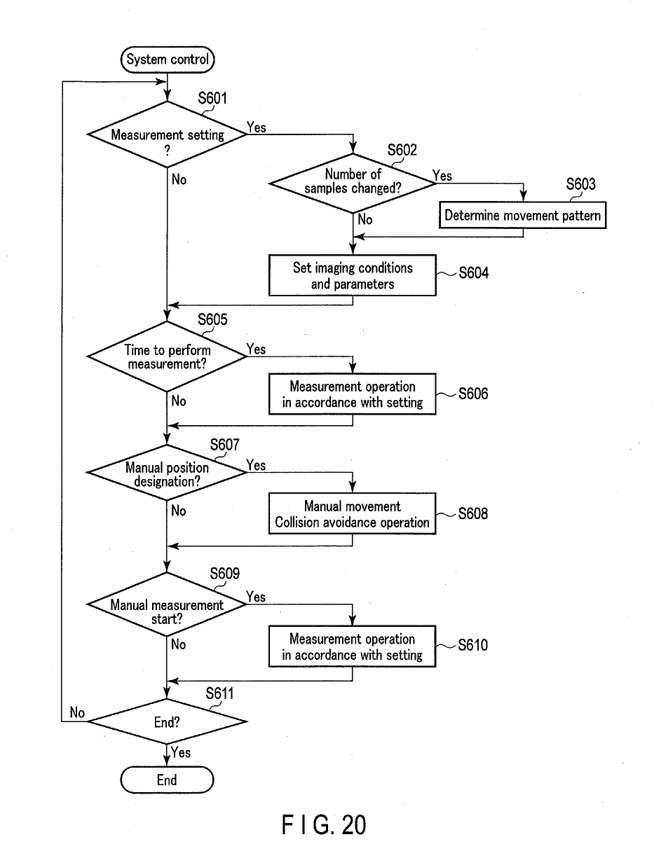

The observation system 1 as a whole performs operations indicated in a flowchart shown in FIG. 20. In step S601, the control section 710 determines whether or not setting related to measurement should be carried out. If the setting is not carried out, the processing advances to step S605. If the setting is carried out, the processing advances to step S602.

In step S602, the control section 710 determines whether the number of samples is changed. If the number of samples is not changed, the processing advances to step S604. If the number of samples is changed, the processing advances to step S603. In step S603, the control section 710 determines a movement pattern in accordance with the number of samples. Subsequently, the processing advances to step S604. In step S604, the control section 710 sets imaging conditions, various parameters, etc. Subsequently, the processing advances to step S605.

In step S605, the control section 710 determines whether or not the current time is a time to perform measurement. If the current time is not a time to perform measurement, the processing advances to step S607. If the current time is a time to perform measurement, the processing advances to step S606. In step S606, the control section 710 performs a measurement operation under the conditions set in step S603, step S604, etc., while moving the image acquisition units 720a, 720b, 720c, and so on. Subsequently, the processing advances to step S607.

In step S607, the control section 710 determines whether or not manual position designation should be performed. If the manual position designation should not be performed, the processing advances to step S609. If the manual position designation should be performed, the processing advances to step S608. In step S608, the control section 710 causes any one of the image acquisition units to manually move in accordance with an input. The control section 710 performs a collision avoidance operation as needed for the image acquisition units other than the image acquisition unit that is manually moved, so that the image acquisition units do not collide with each other as the imaging unit manually moves. Subsequently, the processing advances to step S609.

In step S609, the control section 710 determines whether or not a manual measurement should be started. If a manual measurement should not be started, the processing advances to step S611. If a manual measurement should be started, the processing advances to step S610. In step S610, the control section 710 performs a measurement operation in accordance with the settings. Subsequently, the processing advances to step S611.

In step S611, the control section 710 determines whether or not the processing should be ended. If the processing should not be ended, the processing returns to step S601. If the processing should be ended, the system control processing may be completed.

As described above, the observation system 1 may have any configuration as long as it is the same in function as the observation system of the first embodiment and the second embodiment. The observation system 1 produces the same effect as the first and the second embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An observation system comprising:
a plurality of imaging sections to image one or more samples;
a plurality of driving mechanisms that respectively move the imaging sections to change an imaging position for the samples; and
a control circuit that controls operations of the driving mechanisms and the imaging sections to cause the imaging sections to image the samples, while causing the driving mechanisms to respectively move the imaging sections,
wherein the control circuit imposes different limitations on movement patterns of the imaging sections depending on a characteristic of the samples.

2. The observation system according to claim 1, wherein the control circuit uses the number of samples as the characteristic of the samples, and imposes different limitations on the movement patterns of the imaging sections depending on the number of the samples.

3. The observation system according to claim 1, wherein when the number of the samples is one, the control circuit causes the imaging sections to move in almost the same direction.

4. The observation system according to claim 3, wherein the control circuit causes the imaging sections to individually move so that the imaging sections share imaging of an entirety of the one sample.

5. The observation system according to claim 1, wherein when the number of the samples is two or more, the control circuit causes the imaging sections to respectively image the samples.

6. The observation system according to claim 1, further comprising an input device that receives an instruction of an operator,
wherein the control circuit controls a position of one of the imaging sections based on the instruction input to the input device, and controls a position of another one of the imaging sections so as not to collide with the one of the imaging sections.

7. The observation system according to claim 1, wherein the control circuit imposes further different limitations on movement patterns of the imaging sections depending on a shape or size of the samples, or a shape or size of a support section that supports the imaging sections.

8. The observation system according to claim 1, wherein
the imaging sections have configurations equal to each other; and
the driving mechanisms have configurations equal to each other.

9. An observation method using an observation system including a plurality of imaging sections to image one or more samples, and a plurality of driving mechanisms that respectively move the imaging sections to change an imaging position for the samples, the method comprising:
determining a characteristic of the samples;
determining movement patterns of the imaging sections based on the characteristic of the samples; and
controlling operations of the driving mechanisms and the imaging sections to cause the imaging sections to image the samples, while causing the driving mechanisms to respectively move the imaging sections.
